(19) United States
(12) Patent Application Publication
(10) Pub. No.: US 2016/0207318 A1
(43) Pub. Date: Jul. 21, 2016

(54) LIQUID CONSUMING APPARATUS

(71) Applicant: BROTHER KOGYO KABUSHIKI KAISHA, Nagoya-shi (JP)

(72) Inventors: Taichi SHIRONO, Nagoya-shi (JP); Masataka KAMIYA, Owariasahi-shi (JP)

(73) Assignee: BROTHER KOGYO KABUSHIKI KAISHA, Nagoya-shi (JP)

(21) Appl. No.: 14/995,844

(22) Filed: Jan. 14, 2016

(30) Foreign Application Priority Data
Jan. 19, 2015 (JP) 2015-008167
Jan. 19, 2015 (JP) 2015-008168
Jan. 19, 2015 (JP) 2015-008169
Jan. 19, 2015 (JP) 2015-008170

(51) Int. Cl. B41J 2/175; B41J 2/185

(52) U.S. Cl. CPC B41J 2/175; B41J 2/185; B41J 2002/1856

(57) ABSTRACT

There is provided a liquid consuming apparatus including: a liquid consuming section; a tank having a chamber and a wall; a casing; and a cap. The cap has a columnar-shaped first portion, a second portion having a first nip surface, and a third portion having a second nip surface. One of the cap and the wall is formed of an elastic material. The outer diameters of the first and second nip surfaces are greater than the inner diameter of the inlet port, and a length of the first portion is shorter than a length of the wall. One of the cap and the wall defining the inlet port of the tank is elastically deformed, under the condition that the cap is installed in the inlet port, so that a length between the first and second nip surfaces becomes substantially same as the length of the wall.

### CROSS REFERENCE TO RELATED APPLICATION

The present application claims priorities from Japanese Patent Applications No. 2015-008167 filed on Jan. 19, 2015, No. 2015-008168 filed on Jan. 19, 2015, No. 2015-008169 filed on Jan. 19, 2015, and No. 2015-008170 filed on Jan. 19, 2015, the disclosures of which are incorporated herein by reference in their entireties.

### BACKGROUND

1. Field of the Invention

The present invention relates to a liquid consuming apparatus such as an ink-jet printer.

2. Description of the Related Art

Conventionally, there is known a liquid consuming apparatus such as an ink-jet printer which is provided with a tank (liquid storage apparatus) configured to store a liquid such as an ink, and which is configured to consume the liquid stored in the tank. For example, conventionally, there is known an ink-jet printer provided with an ink tank formed with an ink chamber storing an ink which is to be supplied, via a tube, to a liquid discharging head consuming the ink, a lead-out port via which the ink stored in the ink chamber is led to the tube, and an inlet port via which the ink is poured into the ink chamber.

The inlet port of the ink tank is formed to open at an end portion of a tubular or cylindrical shaped portion which is projected toward outside of the ink chamber, wherein a cap capable of closing/opening the inlet port is detachably attached to the end portion of the cylindrical shaped portion. The cap is provided with a tab portion formed in an upper portion of the cap at a substantially central location thereof, and a circular tube-shaped fitting portion formed in a lower portion of the cap and fitting with the inlet port. Further, when the ink chamber of the ink tank configured as described above is to be replenished with the ink, a user holds the tab portion of the cap with fingers and pulls the fitting portion out from the cylindrical shaped portion, thereby removing or detaching the cap from the inlet port so that the ink is poured into the ink chamber from the released or opened inlet port.

### SUMMARY

An object of the present teaching is to provide a liquid consuming apparatus provided with a cap useful in a liquid consuming apparatus such as the ink-jet printer as described above.

According to an aspect of the present teaching, there is provided a liquid consuming apparatus including:

a liquid consuming section configured to consume liquid;

a tank having a chamber configured to store the liquid which is to be consumed by the liquid consuming section, and a wall defining a part of the chamber, the tank including an inlet port formed in the tank penetrating through the wall;

a casing configured to accommodate a part of the liquid consuming section and the tank; and

a cap configured to be detachably installable in the inlet port, the cap having: a first portion having a first length extending in a first extending direction, and the first portion being provided with a forward end and a basal end opposite the forward end in the first extending direction; a second portion which is provided with a first nip surface continued to the forward end of the first portion; and a third portion which is provided with a second nip surface continued to the basal end of the first portion and facing the first nip surface of the second portion;

wherein the wall defining the inlet port formed with an opening facing a second extending direction, the wall defining the inlet port having a second length in the second extending direction;

wherein one of the cap and the wall, of the tank, defining the inlet port is formed of an elastic material;

wherein outer diameters of the first and second nip surfaces are greater than an inner diameter of the inlet port, and the first length of the first portion in the first extending direction is shorter than the second length; and

wherein the cap is configured to be installed to the inlet port so that the first portion is located inside the inlet port, the first nip surface of the second portion is located inside the tank through the inlet port, and the third portion is located outside the tank.

In the liquid consuming apparatus having the above-described configuration, in a state that the cap is installed in the inlet port, the first nip surface is pressed against the one end of the wall defining the inlet port, and the second nip surface is pressed against the other end of the wall defining the inlet port. With this, the space between the cap and the wall of the tank is sealed at two locations that are between the cap and the opening edge portion of the one end of the wall defining the inlet port, and between the cap and the opening edge portion of the other end of the wall defining the inlet port. In such a manner, the inlet port formed in the tank can be appropriately sealed by the cap. Further, since the inlet port formed in the tank can be closed, without depending on the tight contact between the inner surface of the wall defining the inlet port and the outer circumferential surface of the first portion of the cap, it is possible to reduce the length, in the extending direction of the opening central line of the inlet port, of the wall defining the inlet port.

According to the present teaching, it is possible to provide a liquid consuming apparatus provided with a cap capable of realizing both the appropriate opening/closing of an inlet port formed in a tank and the reduction in the length, in the extending direction of the opening central line of the inlet port, of the wall of the tank defining the inlet port.

### BRIEF DESCRIPTION OF THE DRAWINGS

FIGS. 1A and 1B are perspective views each depicting an example of a multifunction peripheral including an ink-jet printer function according to an embodiment of the present teaching, wherein FIG. 1A is a perspective view depicting a state that a cover is at a closed position, and FIG. 1B is a perspective view depicting a state that the cover is at an opened position.

FIG. 2 is a vertical cross-sectional view schematically depicting the internal structure of a printer unit.

FIG. 3 is a view schematically depicting a relationship between a tank unit and a recording section.

FIG. 4 is a vertical cross-sectional view partially depicting the tank unit in a state that the cover is released (opened) and the tank unit in an exposed state wherein the tank unit is exposed to outside of the multifunction peripheral.

FIG. 5 is a vertical cross-sectional view partially depicting those in the vicinity of an inlet port of a tank of the tank unit.

FIG. 6 is a front view of the tank unit.

FIG. 7 is a side view of a cap.

FIG. 8A is a view of the cap as seen from a direction of a VIII arrow in FIG. 7, depicting an example of a catch portion formed in the cap.

FIG. 8B is a view of the cap as seen from a direction of a VIII arrow in FIG. 7, depicting an example of a modification of the catch portion formed in the cap.

FIG. 9 is a vertical cross-sectional view partially depicting those in the vicinity of the inlet port of the tank of the tank unit, illustrating a state when the cap is being detached from the inlet port of the tank.

FIG. 10 is a side view of the tank unit, illustrating a state of the cap detached from the inlet port of the tank.

FIG. 11 is a vertical cross-sectional view partially depicting those in the vicinity of the inlet port of the tank of the tank unit, illustrating a modification of the inlet port of the tank.

FIG. 12 is a side view of a cap having no arm.

### DESCRIPTION OF THE EMBODIMENTS

A conventional ink tank and a conventional cap are sealed by bringing an inner wall surface of a cylindrical or tubular portion defining an inlet port of the ink tank into tight contact with the outer circumferential surface of a fitting portion of the cap. In order that the cap installed in the inlet port is not detached or does not fall out from the inlet port due to any vibration or any allowable hydraulic or fluid pressure, a sufficient area for tight contact needs to be secured between the inner wall surface of the cylindrical portion and the outer circumferential surface of the fitting portion of the cap. For this purpose, in the conventionally known ink tank and cap, the inlet port is constructed of a cylindrical-shaped wall portion of the tank in which a length, parallel to an opening central line of the opening of the inlet port, is secured. However, in a case that this length of the wall portion is increased, the volume of the ink chamber of the tank is decreased to an extent corresponding to the increased length of the wall portion as described above; at the same time, any spatial limitation is increased with respect to the formation of inlet port in the tank.

The following teaching described in the embodiment has been made in view of the above-described situation, and an object of the present teaching is to provide a liquid consuming apparatus provided with a cap capable of realizing both the appropriate opening/closing of an inlet port formed in a tank and the reduction in the length, in the extending direction of the opening central line of the inlet port, of the wall portion of the tank defining the inlet port.

Further, in a publicly known ink tank, the ink adheres to a portion, of the cap installed in the inlet port, which is exposed inside the ink chamber. Further, due to the pouring of the ink and/or any vibration applied to the ink tank, the ink adheres to an inner circumferential surface of the cylindrical shaped portion defining the inlet port of the ink tank, in some cases. In such cases, the ink adheres also to a peripheral portion of, or a portion in the vicinity of, the fitting portion of the cap installed in the inlet port.

The inner circumferential surface of the cylindrical shaped portion defining the inlet port of the ink tank and the outer circumferential surface of the fitting portion of the cap are in tight contact with each other directly or via the ink so that the ink does not leak or spill out of the ink chamber. Accordingly, when removing the cap from the inlet port, in a case that the cap is pulled out of the inlet port by holding a tab portion of the cap, the cap is detached with force. This force in turn allows the ink adhered to the cap to scatter, leading to such a fear that the ink might adhere to a finger of the user and/or the peripheral portion of or the portion in the vicinity of the inlet port. Further, in a case that the ink adheres to the user's finger and/or the peripheral portion of or the portion in the vicinity of the inlet port as described above, there is such a fear that the ink might adhere to the tab portion of the cap if the user holds and operates the tab portion when installing the cap to the inlet port next time.

The following teaching described in the embodiment has been made in view of the above-described situation, and an object of the present teaching is to provide a liquid storage apparatus provided with a cap capable of realizing both the appropriate opening/closing of an inlet port formed in the tank and the improved operability during installment (attachment) of the cap by an user, and to provide a liquid consuming apparatus provided with the liquid storage apparatus.

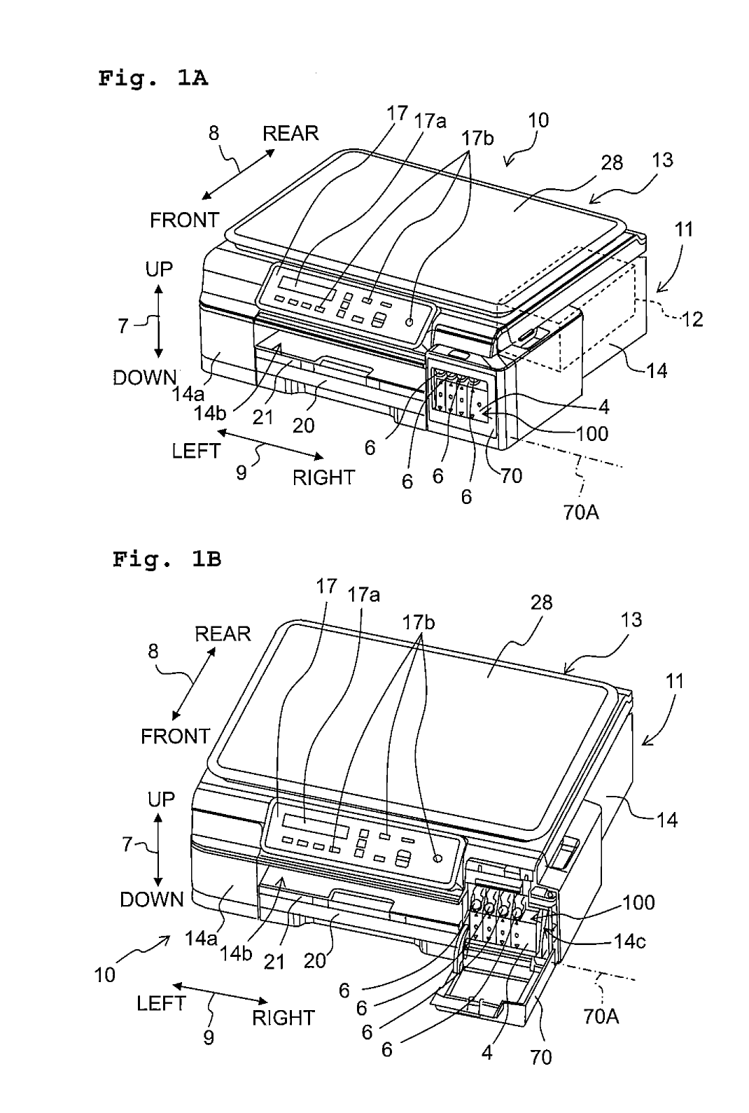

Next, an embodiment of the present teaching will be explained with reference to the drawings. In the following, explanation will be given about a multifunction peripheral having a printer function (printer multifunction peripheral, hereinafter referred to also simply as “multifunction peripheral 10”), as an example of a liquid consuming apparatus. The concepts of up-down direction, front-rear direction and left-right direction in the documents of the present specification and the claims are deemed to be same as an up-down direction 7, a front-rear direction 8 and a left-right direction 9 in the multifunction peripheral 10 as depicted in FIGS. 1A and 1B.

<Overall Configuration of Multifunction Peripheral 10>

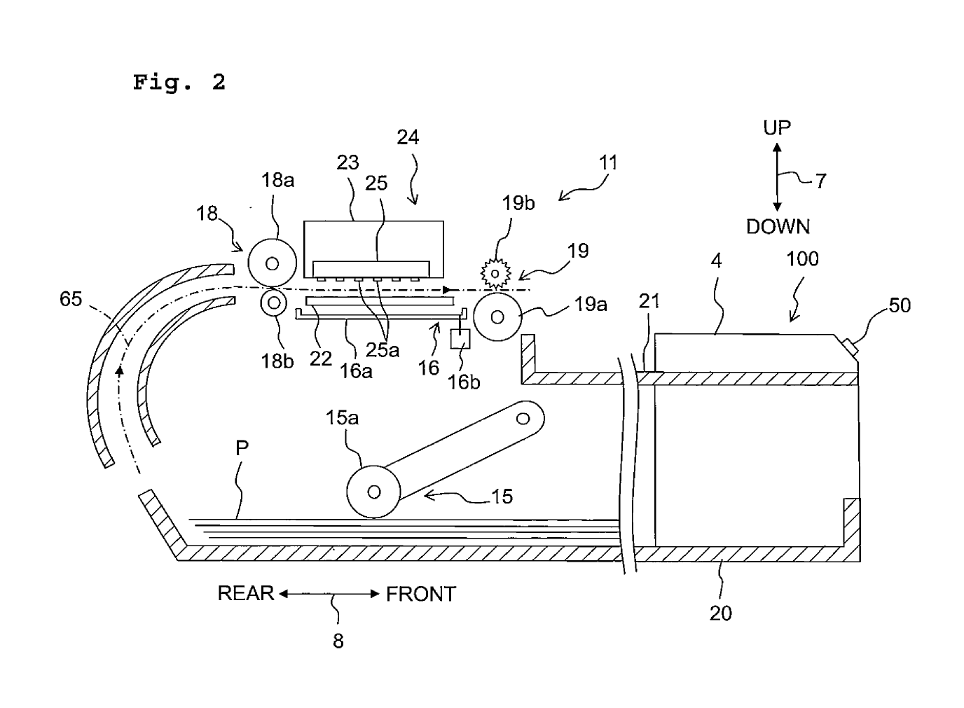

FIGS. 1A and 1B are perspective views each depicting a multifunction peripheral including an ink-jet printer function according to an embodiment of the present teaching, wherein FIG. 1A is a perspective view depicting a state that a cover 70 is at a closed position, and FIG. 1B is a perspective view depicting a state that the cover 70 is at an opened position. As depicted in FIGS. 1A and 1B, the multifunction peripheral 10 according to the present embodiment is formed to have a substantially rectangular parallelepiped shape as a whole, and is provided with a scanner unit 13 provided on an upper portion of the multifunction peripheral 10, a printer unit 11 provided on a lower portion of the multifunction peripheral 10, and a controller 12 configured to control the operation of the multifunction peripheral 10. The printer unit 11 is capable of forming an image on a paper sheet P (paper P; see FIG. 2) in an ink-jet recording system. In the multifunction peripheral 10 having the above-described configuration, the operations of the scanner unit 13 and the printer unit 11 are controlled by the controller 12, thereby allowing the multifunction peripheral 10 to exhibit a plurality of functions such as a copying machine, an ink-jet printer, an image scanner, a facsimile machine, etc.

The external shape of the multifunction peripheral 10 is substantially formed of a casing 14 having a rectangular parallelopiped shape, and a top cover 28 configured to cover an upper portion of the casing 14. An opening 14b is formed in the casing 14 on a front wall 14a at a substantially central portion thereof in the left-right direction 9, and a discharge tray 21 and a feeding tray 20 are arranged inside the opening 14b. Further, an operation panel 17 supported to be tiltable by the casing 14 is disposed at a location above the opening 14b. A liquid crystal display 17a as an output means from the controller 12, an input button 17b as an input means to the controller 12, etc., are provided on the display panel 17.

Furthermore, an opening 14c is provided on the front wall 14a of the casing 14, at a right portion thereof in the left-right direction 9, and the opening 14c is covered by the cover 70 which is openable/closable and which may form a portion of the front wall 14a. A lower portion of the cover 70 is connected to the casing 14, and the cover 70 is rotatable (pivotable) about a rotation axis 70A extending in the left-right direction 9 at a connector at which the cover 70 is connected to the casing 14. More specifically, the cover 70 is rotatable about the rotation axis 70A between a closed position (FIG. 1A) at which the cover 70 covers the opening 14c and an opened position (FIG. 1B) at which the cover 70 allows the opening 14c to be exposed to the outside of the multifunction peripheral 10 (at which the cover 70 does not cover the opening 14c) (see FIG. 1B).

<Printer Unit 11>

Next, the printer unit 11 will be explained in detail. FIG. 2 is a vertical cross-sectional view schematically depicting the overall structure of the printer unit 11. As depicted in FIG. 2, the printer unit 11 includes a feeding section 15, the feeding tray 20, the discharge tray 21, a conveyance roller section 18, a recording section 24, a discharge roller section 19, a platen 22, a liquid recovery device 16, and an ink tank 100. These constituent elements of the printer unit 11 are accommodated inside the casing 14.

The feeding section 15 is provided with a feeding roller 15a which is urged by the self-weight or an elastic force by a spring, etc. toward a sheet or plurality of sheets of paper P accommodated in the feeding tray 20. The feeding roller 15a is rotated and driven by a conveyance motor (not depicted in the drawings) controlled by the controller 12. By the rotation of the feeding roller 15a, the sheets of paper P accommodated in the feeding tray 20 are fed one by one to a conveyance route 65.

The conveyance route 65 is a route which extends upward from a rear end portion of the feeding tray 20 while making a U-turn forwardly, and then the conveyance route 65 reaches the discharge tray 21 via a space between the recording section 24 and the platen 22. The conveyance roller section 18, the recording section 24, and the discharge roller section 19 are arranged in this order from the upstream toward downstream along the conveyance route 65.

The conveyance roller section 18 includes a conveyance roller 18a and a pinch roller 18b which face each other in the up-down direction 7 with the conveyance route 65 interposed therebetween. The conveyance roller 18a is driven by the unillustrated conveyance motor. The pinch roller 18b rotates following the rotation of the conveyance roller 18a. The paper P is fed toward the recording section 24 by being pinched between the conveyance roller 18a and the pinch roller 18b.

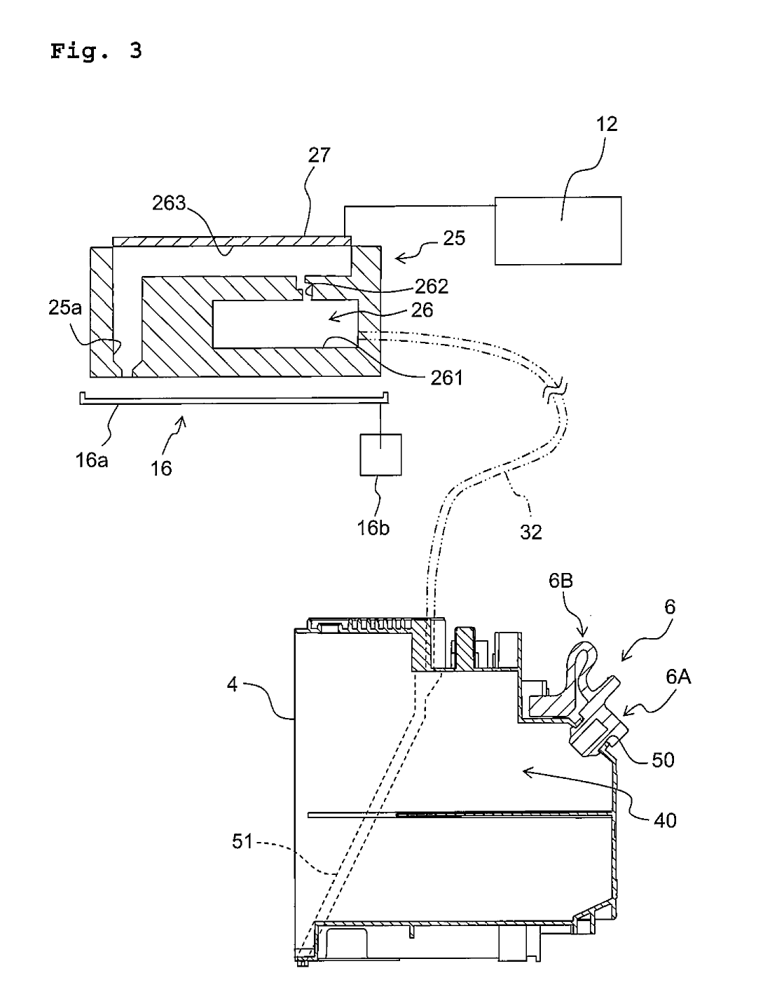

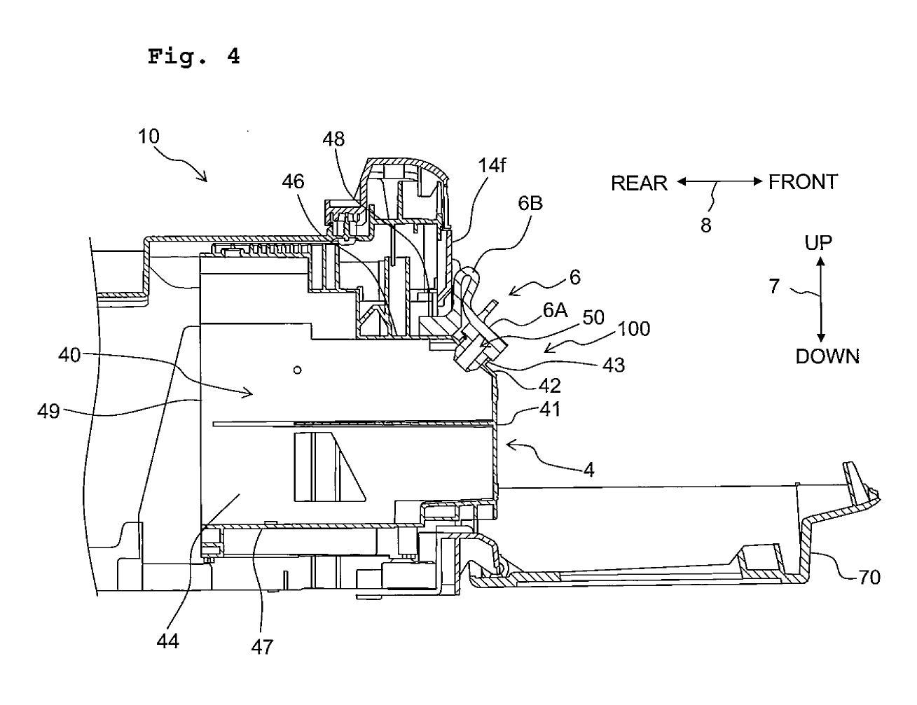

The recording section 24 is an example of the liquid consuming apparatus. FIG. 3 is a view schematically depicting the relationship between the tank unit 100 and the recording section 24. FIG. 3 schematically depicts one of a plurality of nozzles 25a provided on a liquid discharge head 25 of the recording section 24 and one of a plurality of ink chambers 40 provided on the tank unit 100. As depicted in FIGS. 2 and 4, the recording section 24 is provided with the liquid discharging head 25, a carriage 23 on which the liquid discharging head 25 is mounted, and the liquid recovery device 16. Note that the liquid discharging head 25 is also an example of the liquid consuming apparatus. The recording section 24 is arranged to face the platen 22 in the up-down direction 7, with the conveyance route 65 interposed therebetween. Namely, the recording section 24 is arranged to be above the conveyance route 65 in the up-down direction 7, and to face the conveyance route 65. Note that the platen 22 is arranged to face the recording section 24 in the up-down direction 7, and the paper P conveyed by the conveyance roller section 18 is supported by the platen 22 from below.

The carriage 23 is provided with a guide rail extending in the left-right direction 9 and a carriage motor which causes the liquid discharging head 25 to reciprocate in the left-right direction 9 along the guide rail (both of the guide rail and the carriage motor are not depicted in the drawings). Further, a flexible flat cable, which electrically connects the liquid discharging head 25 with a control board having the controller 12 mounted thereon, is extended from the carriage 23 (the flexible flat cable is not depicted in the drawings). The flexible flat cable transmits a control signal output from the controller 12 to the liquid discharging head 25. Furthermore, an ink tube 32 (see FIG. 3), which connects a tank 4 of the tank unit 100 with the liquid discharging head 25, is extended from the carriage 23. The ink tube 32 supplies an ink stored in the tank 4 to the liquid discharging head 25. More specifically, four pieces of the ink tube 32 via which inks of respective colors (black, magenta, cyan and yellow) flow are extended from the tank 4, and are connected to the carriage 23 in a bundled form.

The plurality of nozzles 25a are formed in the lower surface of the liquid discharging head 25. The liquid discharging head 25 is provided with an ink flow channel 26 (an example of a liquid flow channel) constructed of a common ink chamber 261 configured to temporarily store one of the inks supplied from the ink tube 32, pressure chambers 263 each of which is connected to one of the nozzles 25a, supply channels 262 each of which connects the common ink chamber 261 and one of the pressure chambers 263, etc., and an actuator 27 which is configured to apply pressure to the pressure chambers 263. Further, the operation of the actuator 27 is controlled by the controller 12, thereby causing the ink to be discharged, as minute ink droplets, selectively from the nozzles 25a toward a paper P supported by the platen 22 from below, thus forming an image on the paper P. In other words, the liquid discharging head 25 discharges the ink as minute ink droplets from the nozzles 25a toward the paper P supported by the platen 22 from below, thereby forming an image on the paper P.

The liquid recovery section 16 is provided with a liquid recovery body 16a arranged at a position below the platen 22 and/or around the platen 22, and a tank 16b configured to accommodate the liquid recovered by the liquid recovery body 16a. The tank 16b may be any one of ink chambers 40 disposed in the tank 4. The liquid recovery section 16 is capable of recovering a portion of the liquid, such as an ink, discharged from the nozzles 25a of the liquid discharging head 25 but has not landed on the paper P (for example, any purged liquid).

The discharge roller section 19 includes a discharge roller 19a and a spur 19b which face each other in the up-down direction 7 with the conveyance route 65 interposed therebetween. The discharge roller 19a is driven by the unillustrated conveyance motor. The spur 19b rotates following the rotation of the discharge roller 19a. The paper P having the image formed thereon by the recording section 24 is fed toward the discharge tray 21 by being pinched between the discharge roller 19a and the spur 19b.

The tank unit 100 is constructed of a tank 4 which accommodates the inks of respective colors, caps 6 which close inlet ports 50, respectively, formed in the tank 4. Although the tank unit 100 is accommodated inside the casing 14, when the cover 70 is opened, the front surface of the tank unit 100 is thereby exposed to the outside of the casing 14. Namely, when the cover 70 is opened, the caps 6 of the tank unit 100 become accessible via the opening 14c of the casing 14.

<Tank Unit 100>

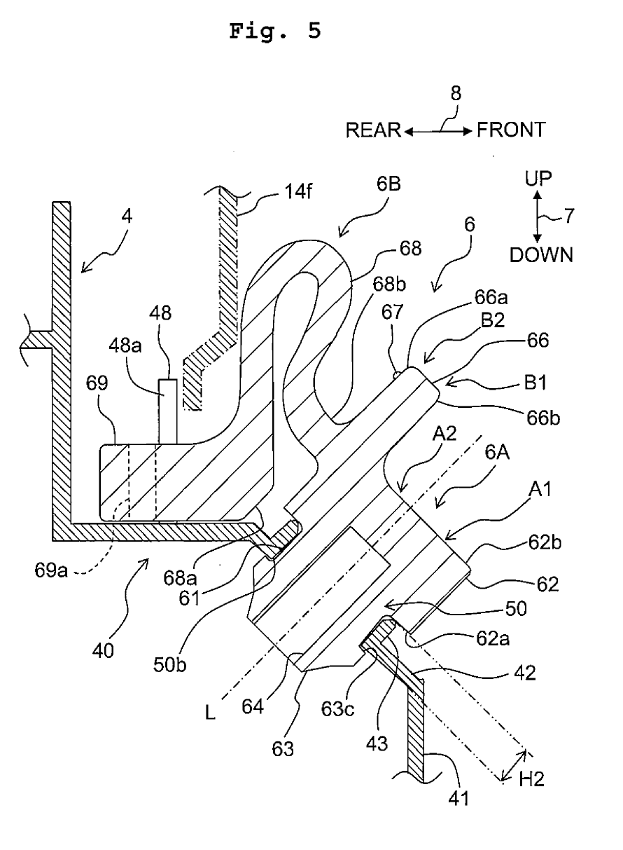

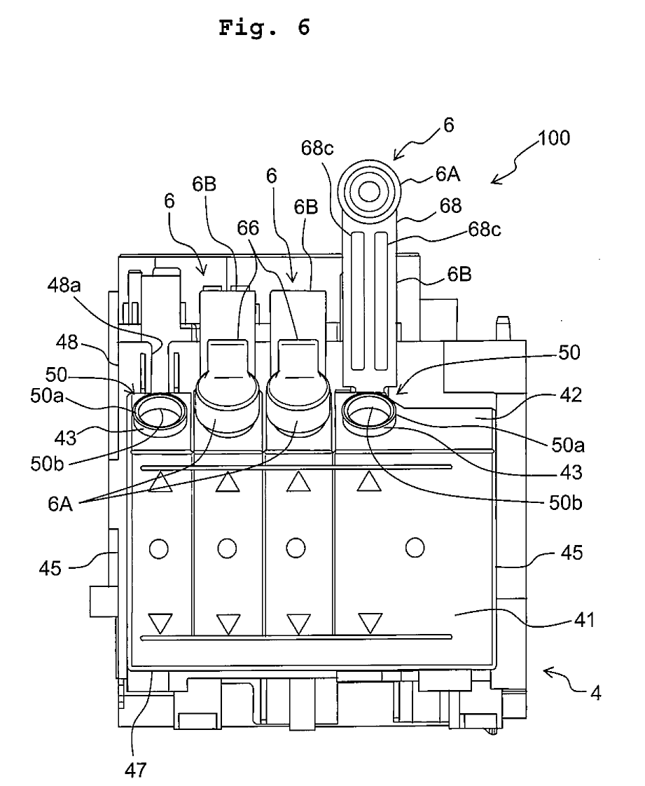

Here, the tank unit 100 will be explained in detail. The tank unit 100 is a liquid storage apparatus according to an embodiment of the present teaching. FIG. 4 is a vertical cross-sectional view partially depicting the tank unit 100 in a state that the cover 70 is opened and a portion of the tank unit 100 is exposed to the outside of the multifunction peripheral 10. FIG. 5 is a vertical cross-sectional view partially depicting those in the vicinity of an inlet port 50 of the tank 4 of the tank unit 100. FIG. 6 is a front view of the tank unit 100. Note that in FIG. 6, one of four caps 6 is omitted to clearly depict the configuration of an arm connecting portion 48 disposed in the tank 4.

As depicted in FIGS. 3 to 6, the tank 4 has a wall formed with the inlet ports 50 via each of which the ink is poured into one of the ink chambers 40 formed inside the tank 4, and a liquid outflow channel 51 via which the ink is fed from each of the ink chambers 40 to the ink tube 32. The tank 4 is formed to have an external shape that is substantially rectangular parallelepiped by a visually checking wall 41 (see-through wall 41) forming the front surface of the tank 4, two side walls 45 forming the both side surfaces in the left-right direction 9 of the tank 4, an upper wall 46 forming the upper surface of the tank 4, a bottom wall 47 forming the bottom surface of the tank 4, and an inclined wall 42 which is connected to the visually checking wall 41 and the upper wall 46 and of which outer surface faces (is oriented to face) obliquely upward. A plurality of partition walls 44 are disposed between the left and right side walls 45, and the internal space in the tank 4 is divided into a plurality of mutually independent ink chambers 40 by the partition walls 44. The rear surface of the tank 4 is sealed by a film 49 fused and adhered to rear end portions respectively of the partition walls 44, the side walls 45, the upper wall 46 and the bottom wall 47.

The internal space of the tank 4 is partitioned into four ink chambers 40 in the left-right direction 9. The black ink, cyan ink, magenta ink and yellow inks are stored in the four ink chambers 40, respectively. Each of the color inks is an example of the liquid. The number of the ink chamber 40 and the color of the ink are not limited to the above examples. Note that although the ink chambers 40 according to this embodiment are each formed of walls made of a resin, it is allowable that the ink chambers 40 are each formed of a bag made of a resin, etc.

The inlet ports 50 as openings configured to allow the inks to be poured into the ink chambers 40 respectively are disposed in the inclined wall 42 of the tank 4. The ink chambers 40 are communicated with the outside of the tank 4 via the inlet ports 50. The tank 4 according to the embodiment has the four ink chambers 40, and four inlet ports 50 are disposed in the inclined wall 42 as a row aligned in the left-right direction 9, corresponding to the four ink chambers 40, respectively.

The tank 4 is provided with cylindrical walls 43 projecting obliquely upward from the outer surface of the inclined wall 42. Each of the inlet ports 50 is formed to penetrate through the inclined wall 42 and one of the cylindrical walls 43. In other words, each of the inlet ports 50 is defined by the wall portions of the tank 4, namely, a portion of the inclined wall 42 and one of the cylindrical walls 43. In this embodiment, each of the inlet ports 50 is formed to have a cylindrical shape. An end portion 50a of the inlet port 50 is open toward the outside of the tank 4 while facing obliquely upward, at a projected end portion of the cylindrical wall 43. On the other hand, the other end portion 50b of the inlet port 50 is open in the inner surface of the inclined wall 42, while facing obliquely downward toward the ink chamber 40.

At an end portion, of the cylindrical wall 43, which can be exposed to the outside of the tank 4 (namely, a projected end portion of the cylindrical wall 43), both the inner wall surface and outer wall surface of the cylindrical wall 43 are chamfered. With this, the thickness of a wall portion in the projected end portion of the cylindrical wall 43 is made to be thinner than a remaining wall portion, different from the wall portion at the projected end portion, in the cylindrical wall 43. As result, the projected end portion of the cylindrical wall 43 is pointed.

The cylindrical wall 43 according to the embodiment is projected from the inclined wall 42 in a front upward direction that is non-orthogonal to the up-down direction 7 and oriented upward from the horizontal direction. Further, the cylindrical wall 43 is projected from the inclined wall 42 in a direction orthogonal to the outer surface of the inclined wall 42. The inlet port 50 formed by the cylindrical wall 43 and the inclined wall 42 is open while facing obliquely upward, namely is open while facing frontward and upward. Namely, an opening central line L of the opening of the inlet port 50 is inclined relative to the up-down direction 7 and the front-rear direction 8. Note that the term “opening central line L” of the inlet port 50 indicates a line linking the center of the one end portion 50a of the inlet port 50 and the center of the other end portion 50b of the inlet port 50, and an extension of this line. In the embodiment, the opening central line L is parallel to a projecting direction in which the cylindrical wall 43 is projected from the inclined wall 42. Further, the opening central line L can be considered also as parallel to a penetrating direction in which the inlet port 50 penetrates through the cylindrical wall 43 and the inclined wall 42.

As described above, each of the inlet ports 50 disposed in the front surface of the tank 4 is exposed to the outside of the multifunction peripheral 10 via the opening 14c of the casing 14 under a condition that the cover 70 is at the opened position (see FIG. 1B). The inlet ports 50 are provided (attached) respectively with caps 6 which are independent from each other. Each of the caps 6 is detachably attached to one of the inlet ports 50 and is capable of opening/closing one of the inlet ports 50. When each of the caps 6 is removed (detached) from one of the inlet ports 50, the inlet port 50 is opened, thereby allowing the ink to be poured into the ink chamber 40 via the released (open) inlet port 50.

<Cap 6>

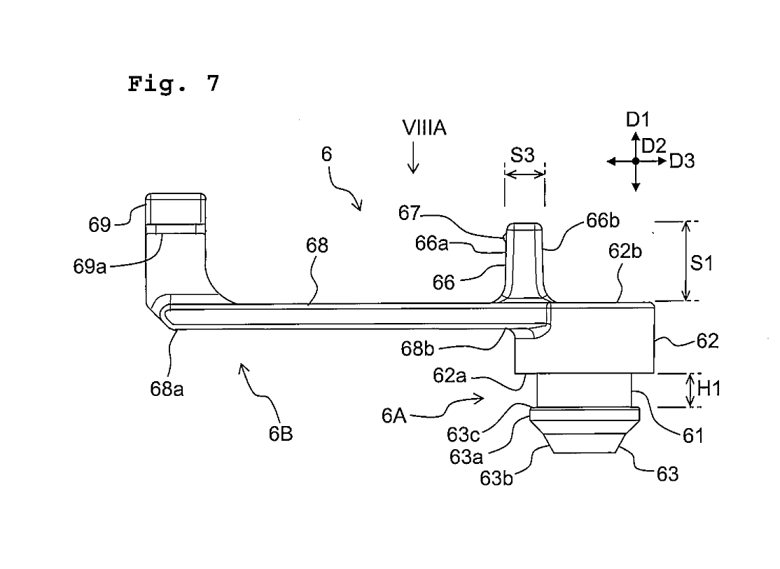

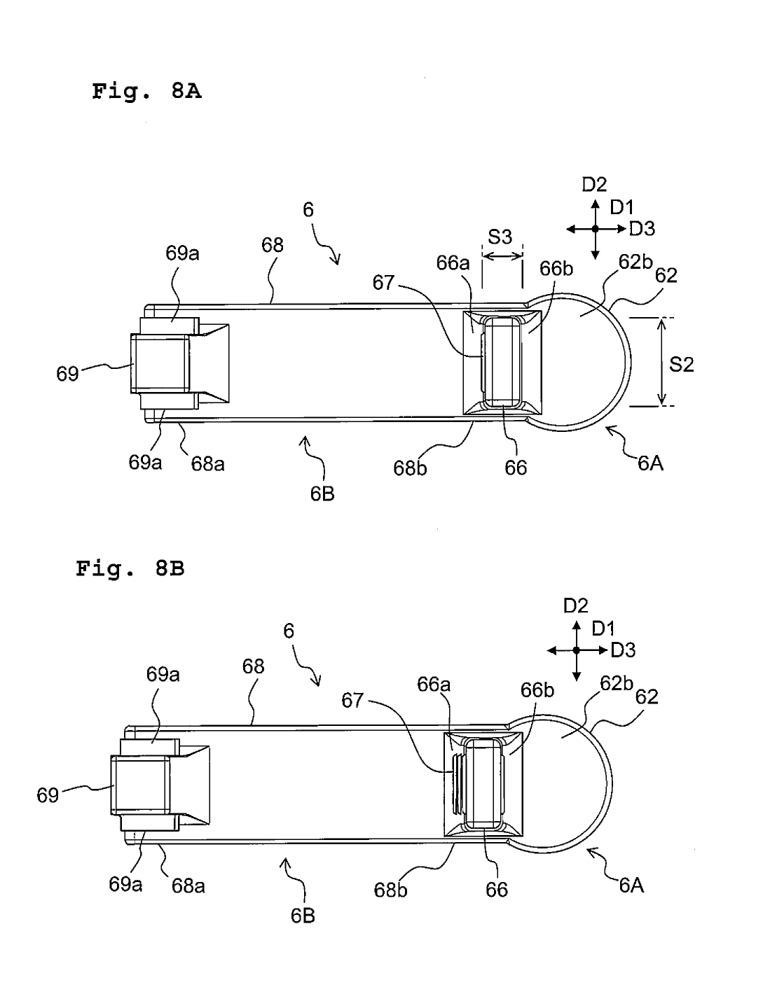

Next, the cap 6 will be explained in detail. The four caps 6 provided on the tank unit 100 according to the embodiment have a same shape. FIG. 7 is a side view of each of the caps 6, and FIG. 8A is a view of each of the caps 6 as seen from a direction of a VIII arrow in FIG. 7. The cap 6 depicted in FIGS. 7 and 8A is not elastically deformed (namely, the cap 6 is in a natural state). As depicted in FIGS. 7 and 8A, the cap 6 has a cap body 6A configured to close the inlet port 50 and an arm 6B configured to connect the cap body 6A to the outer wall of the tank 4. The cap body 6A and the arm 6B of the cap 6 are integrally molded with an elastically deformable material such as rubber, elastomer, etc.

The cap body 6A of the cap 6 has a body 61 (first portion), a flange 62 (third portion) and a holding portion (second portion) 63, and the body 61, the flange 62 and the holding portion 63 are integrally formed. The holding portion 63 is referred to also as a “head 63”. The body 61 has a cylindrical shape (columnar shape). The outer diameter of the body 61 is substantially same as or greater to some extent than the diameter of the inlet port 50. The flange 62 is continued to the basal end portion (basal portion) of the body 61. The flange 62 has a cylindrical shape (columnar shape) of which diameter is greater than that of the body 61. The holding portion 63 is continued to the forward end portion of the body 61. The holding portion 63 has a basal end portion 63a which is formed in a cylindrical shape and of which outer diameter is greater than that of the body 61, and a forward end portion 63b which is formed in a truncated cone-shape and of which outer diameter is decreased from the basal end portion 63a toward the tip of the forward end portion 63b until the outer diameter of the forward end portion 63b becomes smaller than the inner diameter of the inlet port 50. Namely, the holding portion 63 has the basal end portion 63a which is formed in a cylindrical shape and of which diameter is greater than that of the body 61, and the forward end portion 63b which is formed in a truncated cone-shape and of which diameter is decreased from the basal end portion 63a toward the tip of the forward end portion 63b. The outer diameter at the tip of the forward end portion 63b of the holding portion 63 is smaller than the diameter of the inlet port 50. The forward end portion 63b of the holding portion 63 is a portion which is inserted into the inlet port 50 firstly among the cap body 6A when the cap 6 is being installed in the inlet port 50. The cap body 6A having such a configuration exhibits a shape of rotary body that is constricted (slimmed) at the body 61.

The flange 62 and the holding portion 63 have surfaces, respectively, which face each other, with the body 61 interposed therebetween. Namely, a nip surface 63c (first nip surface) of the holding portion 63 and a nip surface 62a (second nip surface) of the flange 62 face each other with the body 61 interposed therebetween. The nip surface 63c of the holding portion 63 is continued to the forward end portion of the body 61. Further, the nip surface 62a of the flange 62 is continued to the basal end portion of the body 61. Under a condition that the cap 6 is in the natural state, namely under a condition that the cap 6 is not elastically deformed, the nip surface 62a of the flange 62 and the nip surface 63c of the holding portion 63 are separated from each other by a distance smaller to some extent than a length H2 (see FIG. 5) of the inlet port 50 in an extending direction of the opening central line L of the inlet port 50. In other words, under the condition that the cap 6 is in the natural state, namely, under the condition that the cap 6 is not elastically deformed, a length H1 in an extending direction of the cylindrical shaped body 61 (see FIG. 7) is smaller to some extent than the length H2 of the inlet port 50 in the extending direction of the opening central line L.

A tab 66 is disposed on an outer surface 62b, of the flange 62, which is a reverse side of the nip surface 62a of the flange 62. The tab 66 is an operation projection held by an under with fingers, etc. so as to operate the cap 6 when the cap 6 (cap body 6A) is to be detached or removed from the inlet port 50 of the tank 4.

The tab 66 is projected from the outer surface 62b of the flange 62, at a location shifted from the central portion of the outer surface 62b, rather than at the central location. The tab 66 according to the embodiment is projected from the outer surface 62b, of the flange 62, at a portion including the outer edge portion of the outer surface 62b. Further, the basal end portion of the tab 66 according to the embodiment is located at a position as an extension of the outer circumferential surface of the body 61 extended parallel to the extending direction of the body 61.

The tab 66 has a first dimension (size) S1 in a first direction D1 parallel to a projection direction in which the tab 66 is projected from the outer surface 62b of the flange 62, a second dimension S2 in a second direction D2 orthogonal to the first direction D1, and a third dimension S3 in a third direction D3 orthogonal to the first and second directions D1 and D2. The second direction D2 is substantially coincident with the horizontal direction under a condition that the cap 6 is installed in the inlet port 50. Further, the second dimension S2 is greater than the third dimension S3, and when the user holds the tab 66, the tab 66 is pinched by two fingers of the user from the third direction D3.

The tab 66 has a first surface 66a facing one direction in the third direction D3, and a second surface 66b that is a reverse side of the first surface 66a. Further, a catch portion (hook portion) 67 is formed in the first surface 66a of the tab 66. The catch portion 67 is formed as at least one projection projected from the first surface 66a in the third direction D3, or as at least one recess recessed in the third direction D3 from the first surface 66a of the tab 66.

Note that in this embodiment, the projection as the catch portion 67 is disposed only in the first surface 66a of the tab 66, and is not disposed in the second surface 66b of the tab 66. It is allowable, however, that the projection or recess may be formed in both of the first surface 66a and the second surface 66b of the tab 66. Note that, however, in such a case, the number and/or shape of the projection or recess formed in the first surface 66a is preferably made to be different from the number and/or shape of the projection or recess formed in the second surface 66b, as depicted in FIG. 8B, in order that the projection or recess is allowed to function as the catch portion 67. As a specific example, the second surface 66b of the tab 66 is formed with a projection projected in the third direction D3 or a recess recessed in the third direction D3 of which number is smaller than that of the projection or recess formed in the first surface 66a.

The arm 6B of the cap 6 has an arm body 68 and an arm root 69 which are integrally formed. An end portion (forward end portion) 68b of the arm body 68 is connected to a peripheral portion of the flange 62 of the cap body 6A. As depicted in FIG. 7, the arm body 68 is formed to have a plate-like shape extending in the third direction D3 from the peripheral portion of the flange 62 of the cap body 6A, under a condition that the arm 6B is in the natural state. Further, the tab 66 is disposed straddling the flange 62 and the arm body 68 which are continued in the third direction D3. Namely, the tab 66 is projected from the outer surface 62b of the flange 62 at a position shifted in the direction toward the arm 6B relative to the central portion in the outer surface 62b of the flange 62.

The arm body 68 is provided with at least one thinned portion 68c extending along the extending direction of the arm body 68 (see FIG. 6). The arm body 68 according to the embodiment is provided with two thinned portions 68c. Owing to the thinned portions 68c, the arm body 68 is prevented from twisting. Further, by adjusting the dimension of the thinned portions 68c, the speed at which the arm 68 stands or rises upward by the elastic recovery from the deformed state is adjusted.

The arm root 69 is disposed at the basal portion of the arm 6B, and is projected in the first direction D1 from a basal end portion 68a of the arm body 68. In the arm 6B in the natural state, the third direction D3 as the extending direction of the arm body 68 and the first direction D1 as the extending direction of the arm root 69 are orthogonal to each other. The arm root 69 is provided with a lock piece 69a which is projected in the second direction D2.

The arm root 69 is connected to an arm connecting portion 48 provided on the tank 4. The arm connecting portion 48 is a wall projecting upward from the upper wall 46 of the tank 4, at a location above and behind (rear of) the inlet port 50. The arm connecting portion 48 of the tank 4 is formed with a groove 48a extending in the up-down direction 7 (see FIG. 6). As depicted in FIGS. 3 and 5, the arm root 69 is inserted into the groove 48a of the arm connecting portion 48, from above the groove 48a, so that the lock piece 69a is located behind the arm connecting portion 48. The arm root 69 is locked with respect to the arm connecting portion 48 by the lock piece 69 so that the arm root 69 is not dropped forwardly off from the groove 48a of the arm connecting portion 48. Further, a vertical wall 14f forming a portion of the casing 14 (or a portion of the frame of the multifunction peripheral 10) is present at a location above the arm root 69, and the vertical wall 14f prevents the arm root 69 from disengaging upwardly from the groove 48a of the arm connecting portion 48 of the tank 4.

Next, an explanation will be given about a state of the cap 6 when the cap 6 is being attached to or detached from the inlet port 50 of the tank 4. Since the front surface of the tank 4 is exposed to the outside of the multifunction peripheral 10 via the opening 14c disposed on the front surface 14a of the casing 14 of the multifunction peripheral 10, the user performs an operation for attaching/detaching the cap 6 with respect to the inlet port 50 in principle from a side in front of the multifunction peripheral 10. Note that the attachment/detachment of the cap 6 is performed in a state that the tank 4 assumes a pouring posture. Here, the term “pouring posture” is a posture of the tank 4 when the ink is poured into the ink chamber 40 through the inlet port 50. In the multifunction peripheral 10 according to the present embodiment, the pouring posture of the tank 4 is same as a normal posture of the tank 4 in a case that the ink is supplied from the tank 4 to the liquid discharging head 25 when printing is performed by the printer unit 11, and is the posture of the tank 4 which has been explained above in the embodiment and will be explained in the following. Namely, the inlet port 50 of the tank 4 in the pouring posture is open while facing obliquely upward, namely is open while facing frontward and upward. Note that if the pouring posture of the tank 4 is different from the normal posture, the posture of the tank 4 is changed from the normal posture to the pouring posture of the tank 4 explained in the embodiment when the ink is poured into the ink chamber 40 via the inlet port 50.

In a case that the cap 6 is to be installed in the inlet port 50 of the tank 4, the cap body 6A is pressed, firstly from the holding portion 63, into the inlet port 50 in a state that the holding portion 63 of the cap body 6A is positioned with respect to the one end portion 50a of the inlet port 50, until the flange 62 abuts against (makes contact with) the projected end portion of the cylindrical wall 43. For example, the user positions the holding portion 63 of the cap 6 with respect to the one end portion 50a of the inlet port 50 of the tank 4 and presses the outer surface 62b of the flange 62 with the inner surface of a finger, thereby allowing the holding portion 63 and the body 61 to pass through the one end portion 50a of the inlet port 50 and to be pressed into the inlet port 50.

When the body 61 and the holding portion 63 enter into the inlet port 50, the holding portion 63 having the outer diameter greater than the inner diameter of the inlet port 50 is elastically deformed such that the holding portion 63 can pass through the inlet port 50. The outer surface 62b of the flange 62 is pressed (pushed) toward the inlet port 50 until the projected end portion of the cylindrical wall 43 abuts against the flange 62. When the projected end portion of the cylindrical wall 43 abuts against the flange 62 and the flange 62 is pressed (pushed) further, the projected end portion which is pointed to some extent is stuck into the flange 62, thereby allowing the holding portion 63 to reach the ink chamber 40. When the holding portion 63 of which outer diameter has compressed inside the inlet port 50 passes through the inlet port 50 and reaches the ink chamber 40, the holding portion 63 is elastically recovered and returns to the original shape. When the holding portion 63 is elastically recovered, the user operating the cap 6 feels a click feeling, and thus the user can know that the cap 6 is correctly installed in the inlet port 50.

As depicted in FIG. 5, under the condition that the cap 6 is installed in the inlet port 50, the body 61 of the cap body 6A is located inside the inlet port 50, the flange 62 is located outside the tank 4, and holding portion 63 is located inside the ink chamber 40.

In a state that the cap 6 is installed in the inlet port 50 as described above, the cap body 6A is elastically deformed so that a distance between the nip surface 62a of the flange 62 and the nip surface 63c of the holding portion 63 in a direction parallel to the opening central line L of the inlet port 50 becomes substantially same as the length H2 between the one end portion 50a and the other end portion 50b of the inlet port 50 in the direction parallel to the opening central line L (namely, the length of the cylindrical wall 43 parallel to the opening central line L of the inlet port 50). With this, the nip surface 62a of the flange 62 is pressed against the projected end portion of the cylindrical wall 43 defining the one end portion 50a of the inlet port 50, and the nip surface 63c of the holding portion 63 is pressed against the inner surface of the inclined surface 42 defining the other end portion 50b of the inlet port 50. In other words, the cylindrical wall 43 and the inclined wall 42 are sandwiched and pressurized from both sides respectively with the flange 62 and the holding portion 63, due to the elastic deformation of the cap body 6A. In such a manner, the one end portion 50a of the inlet port 50 is sealed by the flange 62 of the cap 6, and the other end portion 50b of the inlet port 50 is sealed by the holding portion 63 of the cap 6 as well. Namely, in the state that the cap 6 is installed in the inlet port 50, the cap 6 and the tank 4 are sealed at two locations. Further, since the outer diameter of the body 61 is substantially same as or greater to some extent than the diameter of the inlet port 50, the body 61 makes tight contact with the wall portion, of the tank 4, defining the inlet port 50, namely makes tight contact with a surface defining the inlet port 50 in the cylindrical wall 43 and the inclined wall 42. With this, the inlet 50 is sealed by the body 61. Specifically, the cap 6 and the tank 4 are sealed also in the outer circumferential surface of the body 61.

The material for forming the cap 6, the thicknesses of the flange 62 and the holding portion 63, etc. are designed such that under the condition that the cap 6 is installed in the inlet port 50 as described above, the cap 6 has a withstanding pressure exceeding a discharging pressure of the liquid from the nozzles 25a of the liquid discharging head 25 of the recording section 24. Namely, the pressure resistance performance of the ink chamber 40 is greater than the pressure resistance performance of each of the ink flow channel 26 and the nozzles 25a of the liquid discharging head 25. With this, in a case that the ink chamber 40 of the tank 4 is in an over-pressure state, the ink in the ink chamber 40 of the tank 4 inflows into the ink flow channel 26 of the liquid discharging head 25 and then the ink is discharged from the nozzles 25a, thereby resolving the over-pressure state of the ink chamber 40. The ink discharged from the nozzles 25a is recovered by the liquid recovery device 16. In such a manner, it is possible to resolve the over-pressure state in the ink chamber 40 of the tank 4 without removing the cap 6 from the inlet port 50. Therefore, any ink does not adhere to user in this operation. Further, it is also possible to prevent any leakage of the ink from the tank 4.

Further, regarding the cap 6 when the cap 6 is installed in the inlet port 50 as described above, the force in the direction for pulling the cap 6 from the inlet port 50 is applied to the cap 6 in some cases due to the vibration during the transportation, the variation in atmospheric pressure, and further due to the force applied to the cap 6 by the arm 6B attempting the elastic recovery from the bent state, etc. In view of this, the two nip surfaces 63c and 62a of the cap 6 sandwich the cylindrical wall 43 defining the inlet port 50, and further the nip surface 63c of the holding portion 63 is held onto the wall portion of the inlet port 50. This makes the cap 6 be hardly removable (detachable) from the inlet port 50. With this, the cap 6 can be prevented from automatically detach from the inlet port 50 without any operation by the user, which in turn makes it possible to prevent any leakage of the ink.

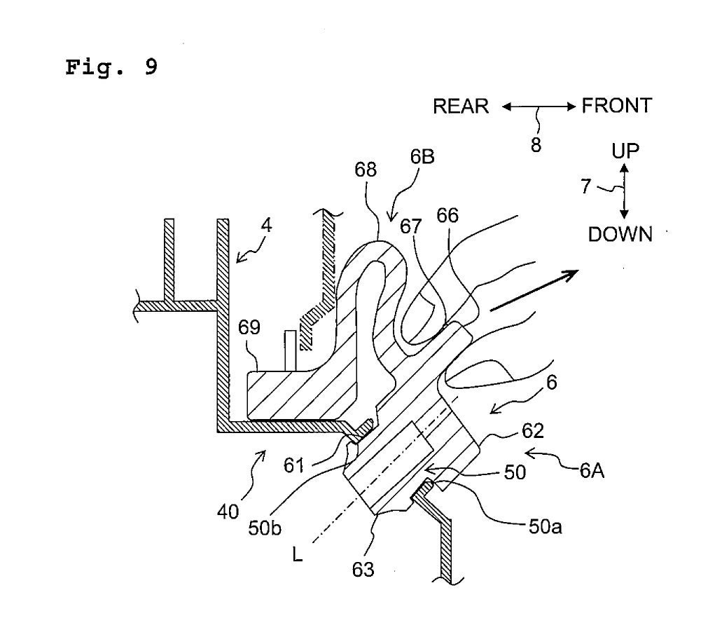

In a case that the cap 6 installed in the inlet port 50 is to be removed (detached) from the inlet port 50, the body 61 and the holding portion 63 of the cap 6 which are inserted respectively into the inlet port 50 and the ink chamber 40 of the tank 4 are pulled out to the outside of the tank 4 via the one end portion 50a of the inlet port 50, as depicted in FIG. 9. Here, the user touches the first surface 66a of the tab 66 with a finger, and touches the second surface 66b of the tab 66 with another finger, thereby holds the tab 66 of the cap 6 with the two fingers, and pulls the tab 66 obliquely upward, namely frontward and upward, or frontward (namely, toward the side in front of the user, toward the user), thereby making it possible to pull the body 61 and the holding portion 63 of the cap 6 from the inlet port 50 of the tank 4 to the outside of the tank 4.

The outer surface 62b of the flange 62 of the cap 6 installed in the inlet port 50 faces the outside of the tank 4, and the outer surface 62b intersects the opening central line L of the inlet port 50. Further, the tab 66 of the cap 6 is projected from the outer surface 62b of the flange 62 at the location (position) not overlapping with the opening central line L of the inlet port 50. It is desirable that the basal end portion of the tab 66 is located to be nearer to the outer edge portion of the outer surface 62b than the opening central line L. It is more desirable that the tab 66 is projected from the outer surface 62 from a portion including the outer edge portion of the outer surface 62b. It is further more desirable that the basal end portion of the tab 66 is located on an extension line extended from the outer edge portion of the inlet port 50 in parallel to the opening central line L.

Further in this embodiment, in a case that the outer surface 62b of the flange 62 of the cap 6 installed in the inlet port 50 is divided into a front-side half portion (front half) A1 and a back-side half portion (rear half) A2 as seen from the user, the tab 66 is projected from the back-side half portion A2 of the outer surface 62b of the flange 62. Further, in the cap 6 installed in the inlet port 50, the tab 66 is located above the opening central line L. Specifically, in the cap 6 installed in the inlet port 50, the tab 66 is located above the point of intersection of the opening central line L with the outer surface 62b.

In such a manner, since the tab 66 is projected from the position not overlapping with the opening central line L, the following effect can be obtained. Namely, as depicted in FIG. 9, when the user pulls the tab 66, of the cap 6 installed in the inlet port 50, obliquely upwardly, namely pulls the tab 66 frontward and upward, or frontward, the cap 6 that is an elastic body is elastically deformed to be elongated in the direction in which the tab 66 is pulled. The tab 66 and a portion in the vicinity of the tab 66 (hereinafter referred to as the “vicinity portion” or “vicinity portion to the tab 66” in some cases) in the cap body 6A of the cap 6 are elongated to an extent greater than other portion of the cap body 6A which is different from the tab 66 and the vicinity portion thereof. Then, the flange 62 of the cap 6 is separated from the cylindrical wall 43 defining the inlet port 50 firstly at the vicinity portion of the tab 66, and then the flange 62 is separated from the cylindrical wall 43 in the order of nearness from the vicinity portion of the tab 66 in a direction from the vicinity portion of the tab 66 toward a portion on the opposite side to the vicinity portion with the opening central line L interposed therebetween. When the flange 62 is separated from the cylindrical wall 43, the body 61 connected to the flange 62 is separated from the surface in the cylindrical wall 43 and the inclined wall 42 which defines the inlet port 50, thereby releasing the tight contact between the body 61 and the surface defining the inlet port 50. The body 61 is separated from the surface defining the inlet port 50 in the order of nearness from a vicinity portion of the tab 66 in the direction from the vicinity portion of the tab 66 toward a portion on the opposite side to the vicinity portion with the opening central line L interposed therebetween. Namely, the tight contact between the body 61 and the surface defining the inlet port 50 is released in the order of nearness from the vicinity portion of the tab 66 in the direction from the vicinity portion of the tab 66 toward the portion on the opposite side to the vicinity portion with the opening central line L interposed therebetween.

In a case that a tab is disposed at the central portion of the cap installed in the inlet port, as in the publicly known ink-jet printer, and that the tab is pulled, substantially uniform sliding resistance is generated between the cap and the wall surface defining the inlet port, along the entire circumference of the inlet port. In contract, when the tab 66 is pulled in the tank unit 100 according to the present embodiment, the sliding resistance between the cap 6 and the wall surface defining the inlet port 50 (the surface in the cylindrical wall 43 and the inclined wall 42 which defines the inlet port 50) is not uniform along the entire circumference of the inlet port 50; rather, in a contact portion between the cap 6 and the wall surface defining the inlet port 50, a portion is generated at which the sliding resistance is smaller than other portion of the cap 6, namely a portion is generated in the cap 6 at which the cap 6 can be pulled out from the inlet port 50 more easily than other portion of the cap 6. Further, the cap 6 is pulled out from the inlet port 50 from the portion at which the cap 6 can be easily pulled out from the inlet port 50, in the order of nearness from this easily pulled-out portion. Accordingly, it is possible to reduce the operation load applied when pulling the cap 6 out of the inlet port 50, as compared with the publicly known ink-jet printer. With this, it is possible to reduce the force generated when the cap 6 is pulled out from the inlet port 50, thereby making it possible to reduce the amount of the ink scattering from the cap body 6A.

Further, since the inlet port 50 is open to the outside of the tank 4 while facing obliquely upward, namely upward and frontward; under the condition that the cap 6 is installed in the inlet port 50, the tab 66 is located above the opening central line L (specifically, located above the point of intersection of the opening central line L with the outer surface 62b), namely the tab 66 is located on the back side (rear side) of the opening central line L as viewed by the user. Therefore, the user is psychologically encouraged to pull the tab 66 toward the user, namely frontward. Accordingly, the direction in which the user pulls the tab 66 is inclined frontward relative to the opening central line L. Thus, the cap 6 is deformed such that a portion, of the cap 6, located near the tab 66 is separated from the surface defining the inlet port 50, and the portion near to the tab 66 in the cap 6 can be further easily pulled from the inlet port 50. Further, the direction in which the user pulls the tab 66 is inclined frontward relative to the opening central line L. Accordingly, when the user pulls the cap 6 out of the inlet port 50, the holding portion 63 to which the ink is adhered with high probability faces rearward, namely faces the side opposite to the user, thereby making it possible to suppress any scattering of the ink toward the user.

Further, under the condition that the cap 6 is installed in the inlet port 50, the second direction D2 is substantially coincident with the horizontal direction, namely the left-right direction 9, and the first surface 66a of the tab 66 is located above the second surface 66b. The user touches the first surface 66a of the tab 6 from thereabove with a finger, and touches the second surface 66b of the tab 66 from therebelow with another finger, thereby holding the tab 66 of the cap 6 with the two fingers. When the user holds the tab 66 of the cap 6 with the fingers, the catch portion 67 catches the finger, and the surface provided with the catch portion 67 (namely, the first surface 66a) is less likely to slip as compared with the other surface (namely, the second surface 66b). Accordingly, the user is psychologically encouraged to pull the tab 66 toward the user, namely frontward, by catching the catch portion 67 with the finger. Accordingly, the direction in which the user pulls the tab 66 is inclined frontward relative to the opening central line L. Thus, the cap 6 is deformed such that the portion, of the cap 6, located near the tab 66 is separated from the surface defining the inlet port 50, and the portion near to the tab 66 in the cap 6 can be further easily pulled from the inlet port 50. Further, the direction in which the user pulls the tab 66 is inclined frontward relative to the opening central line L. Accordingly, when the user pulls the cap 6 out of the inlet port 50, the holding portion 63 to which the ink is adhered with high probability faces rearward, namely faces the side opposite to the user, thereby making it possible to suppress any scattering of the ink toward the user.

Further, in the state that the cap 6 is installed in the inlet port 50, the arm body 68 of the arm body 6B extends upward from the basal end portion 68a, then is bent, then extends downward, and the forward end portion 68b of the arm body 68 is connected to the peripheral portion of the flange 62. In the cap 6 installed in the inlet port 50 in such a manner, the tab 66 is positioned between the bent portion of the arm body 68 and the opening central line L of the inlet port 50.

As described above, when the user holds, with fingers, the tab 66 of the cap 6 installed in the inlet port 50, the arm body 68 (in particular, the bent portion of the arm body 68) is present at the location above the inlet port 50. The user is psychologically encouraged to pull the tab 66 while avoiding the bent portion of the arm body 68. Namely, the user is psychologically encouraged to pull the tab 66 frontward (toward the user himself/herself). Accordingly, the direction in which the user pulls the tab 66 is inclined frontward relative to the opening central line L. Thus, the cap 6 is deformed such that a portion, of the cap 6, located near the tab 66 is separated from the surface defining the inlet port 50, and the portion near to the tab 66 in the cap 6 can be further easily pulled from the inlet port 50. Further, the direction in which the user pulls the tab 66 is inclined frontward relative to the opening central line L. Accordingly, when the user pulls the cap 6 out of the inlet port 50, the holding portion 63 to which the ink is adhered with high probability faces rearward, namely faces the side opposite to the user, thereby making it possible to suppress any scattering of the ink toward the user.

Although the cap 6 is made to be easily removable from the inlet port 50 when the cap 6 is to be removed from the inlet port 50 as described above, in some cases the cap 6 is still difficult to be removed from the inlet port 50 due to any tight contact between the outer circumferential surface of the body 61 of the cap 6 and the inner surface of the cylindrical wall 43 defining the inlet port 50. In such cases, it is allowable that the user performs an operation for pressing the outer surface 62b of the flange 62 with the inner surface of a finger, before pulling the tab 66 or when starting pulling of the tab 66, so as to press the flange 62 into the inlet port 50. By pressing the outer surface 62b of the flange 62 in such a manner, the cap 6 is deformed such that the flange 62 enters into the inside of the inlet port 50 so as to push and squeeze a hollow 64 of the cap body 6A. It is expected that this deformation releases the tight contact between the outer circumferential surface of the body 61 and the inner surface of the cylindrical wall 43 defining the inlet port 50, and this deformation allows the holding portion 63 to deform to be easily pass through the other end portion 50b of the inlet port 50.

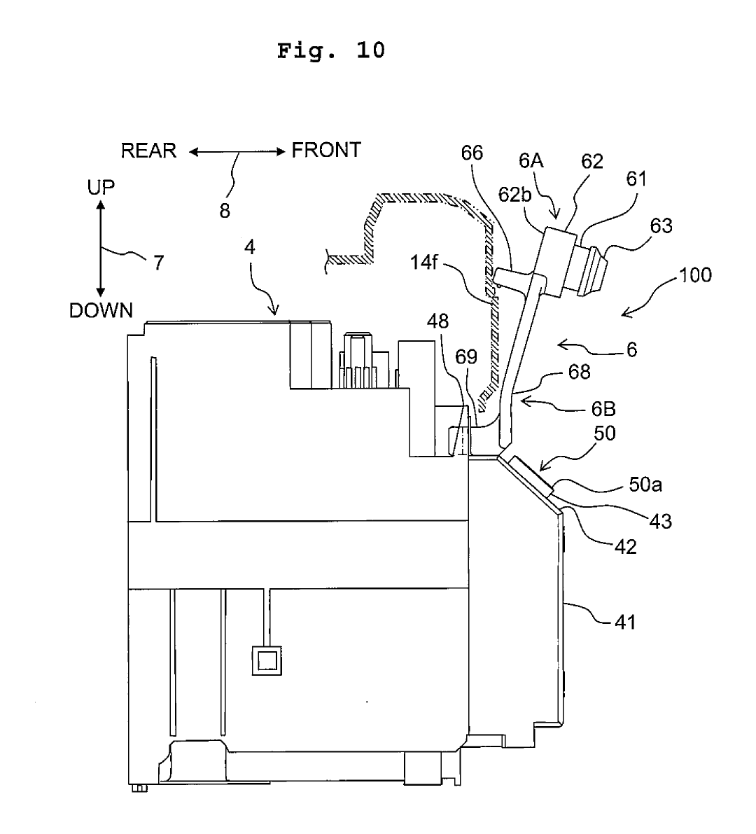

After the cap 6 has been detached from the inlet port 50 as described above, the arm body 68 is elastically restored such that the extent of the bending of the arm body 68 is mitigated. As a result, the cap body 6A of the cap 6 pivots or rotates upward about the basal end portion 68a of the arm body 68 as the rotational center, and the arm body 68 stands upward, as depicted in FIG. 10. The basal portion of the arm 6B is connected to the tank 4 such that at least the basal portion of the arm 6B stands up under a condition that the arm is in the natural state. Specifically, the arm root 69 is connected to the tank 4 such that the extending direction of the arm root 69 is substantially horizontal, and the extending direction of the arm root 69 of the cap 6 is substantially orthogonal to the extending direction of the basal end portion 68a of the arm body 68. With this, the arm body 68 stands up until the basal end portion 68a of the arm body 68 is substantially vertical.

As described above, since the arm body 68 is in a standing (raised) state in a state that the cap 6 is detached from the inlet port 50, the cap body 6A connected to the forward end portion 68b of the arm body 68 has also rotated upward. In such a manner, the cap body 6A is maintained at a location apart from the inlet port 50. Therefore, when an operation is performed so as to pour the ink into the ink chamber 40 via the inlet port 50, the operation is not hindered by the cap 6. Further, since the holding portion 63, in the cap body 6A, which has been located inside the ink chamber 40 and to which the ink is adhered with high probability becomes visible by the user, it is possible to prevent any error in the color of the ink to be poured into the ink chamber 40 when pouring the ink into the ink chamber 40 via the inlet port 50.

As described above, when the arm body 68 stands up by the elastic recovery, the tab 66 of the cap 6 abuts against (makes contact with) the vertical wall 14f of the casing 14 before the outer surface 62b of the flange 62 and the arm 6B. This regulates any further upward rotational movement of the arm body 68. Further, under a condition that the arm body 68 is in a raised state, a gap is defined between the vertical wall 14f of the casing 14 and the outer surface 62b of the flange 62 of the cap 6, by the tab 66 interposing between the vertical wall 14f and the outer surface 62b, the gap being such an extent that a finger of the user can be inserted in the gap. Thus, when the cap 6 is to be installed in the inlet port 50 next time, the user inserts a finger into the gap between the vertical wall 14f of the casing 14 and the outer surface 62b of the flange 62 of the cap 6 and presses the outer surface 62b of the flange 62 with that finger, and thus the user can install the cap 6 in the inlet port 50 without allowing the ink to adhere to the user's finger.

Note that, as depicted in FIG. 10, in a state that the cap 6 is not installed in the inlet port 50, the pivot motion (rotation) of the cover 70 from the opened position to the closed position is inhibited by the cap body 6A which has been rotated upwardly and the arm 6B which is in the standing posture. Namely, when the cap 6 is not installed in the inlet port 50, the cover 70 cannot be closed. With this, it is possible to suppress the closing of the cover 70 in a state that the cap 6 remains detached from the inlet port 50, namely, to suppress the usage of the multifunction peripheral 10 in a state that the inlet port 50 remains opened.

As explained above, the multifunction peripheral 10 as the liquid consuming apparatus according to the embodiment is provided with the recording section 24 as the liquid consuming section; the tank 4 having the ink chamber 40 (liquid storing chamber) configured to store the ink (liquid) which is to be consumed by the recording section 24 therein and the inlet port 50 which is formed penetrating through the inclined wall 42 (wall portion) partitioning the ink chamber 40 from the outside thereof and via which the liquid is poured into the ink storing chamber 40; the cap 6 which is detachably attached to the inlet port 50 and which is capable of opening/closing the inlet port 50; and the casing 14 configured to accommodate at least a part of the recording section 24 and the tank 4. One of the cap 6 and the cylindrical wall 43 (wall portion) defining the inlet port 50 of the tank 4 is constructed of an elastic material.

The cap 6 has the columnar shaped body 61 (first portion) which is located inside the inlet port 50 under the condition that the cap 6 is installed in the inlet port 50; the holding portion 63 (second portion) which is the portion located at inside of the tank 4 under the condition that the cap 6 is installed in the inlet port 50 and which is provided with the nip surface 63c (first nip surface) continued to the forward end portion of the body 61; and the flange 62 (third portion) which is the portion located at outside of the tank 4 under the condition that the cap 6 is installed in the inlet port 50, which is provided with the outer surface 62b facing the outside of the tank 4, and the nip surface 62a (second nip surface) continued to the basal end portion of the body 61 and facing the nip surface 63c of the holding portion 63. Further, the outer diameters of the nip surface 63c and the nip surface 62a are greater than the inner diameter of the inlet port 50, and the length of the body 61 in the extending direction of the body 61 is shorter than the length, in the extending direction of the opening central line L of the inlet port 50, of the wall portion defining the inlet port 50. Furthermore, under the condition that the cap 6 is installed in the inlet port 50, the cap 6 is elastically deformed so that the length between the nip surfaces 63c and 62a in the extending direction of the opening central line L of the inlet port 50 becomes substantially same as the length, of the wall portion defining the inlet port 50, in the extending direction of the opening central line L of the inlet port 50. Here, the wall portion defining the inlet port 50 of the tank 4 is allowed to be elastically deformed, instead of the cap 6.

With this, in a state that the cap 6 is installed in the inlet port 50, the nip surface 63c is brought into pressurized contact with the one end portion of the wall portion defining the inlet port 50, and the nip surface 62a is brought into pressurized contact with the other end portion of the wall portion defining the inlet port 50. With this, the space between the cap 6 and the wall portion of the tank 4 is sealed at two locations, namely between the cap 6 and the opening edge of the one end portion of the wall portion defining the inlet port 50 and between the cap 6 and the opening edge of the other end portion of the wall portion defining the inlet port 50. In such a manner, the inlet port 50 formed in the tank 4 can be appropriately closed by the cap 6. Further, it is possible to close the inlet port 50 formed in the tank 4 without depending on the tight contact between the inner surface of the wall portion defining the inlet port 50 and the outer circumferential surface of the body 61 of the cap 6, thereby making it possible to reduce the length, of the wall portion defining the inlet port 50, parallel to the opening central line L of the inlet port 50. As described above, it is possible to provide the multifunction peripheral 10 provided with the cap 6 capable of realizing both the appropriate opening/closing of the inlet port 50 formed in the tank 4 and the reduction in the length, in the extending direction of the opening central line L of the inlet port 50, of the wall portion of the tank 4 defining the inlet port 50.

Further, in the multifunction peripheral 10 according to the present embodiment, the holding portion 63 of the cap 6 has the basal end portion 63a of which outer diameter is greater than that of the body 61, and the forward end portion 63b which is the portion inserted into the inlet port firstly among the cap 6, and of which outer diameter is decreased from the basal end portion 63a toward the tip of the forward end portion 63b until the outer diameter thereof becomes smaller than the inner diameter of the inlet port 50.

With this, when installing the cap 6 in the inlet port 50, the forward end portion 63b of the holding portion 63 can be inserted smoothly into the inlet port 50.

Furthermore, in the multifunction peripheral 10 according to the present embodiment, the cap 6 further has the arm 6B (arm) linking the outside of the tank 4 and the flange 62; and under the condition that the cap 6 is installed in the inlet port 50, the arm 6B is bent by elastic deformation.

With this, since the cap 6 removed from the inlet port 50 is maintained at a location near or around the inlet port 50, there is no need to particularly secure any space to place the cap 6 removed from the inlet port 50. Moreover, the flange 62 of the cap 6 is connected to the arm 6 in a manner as describe above; and thus under the condition that the cap 6 is installed in the inlet port 50, the force in the direction for pulling the cap 6 from the inlet port 50 is applied to the cap 6 due to the elastic recovery (elastic restoration) of the arm 6B. However, since the wall portion defining the inlet port 50 is held (sandwiched) by the two nip surfaces 63c and 62a of the cap 6 and further the nip surface 63c of the holding portion 63 is held by the wall portion of the inlet port 50, the cap 6 does not detach from the inlet port 50, resisting the force applied by the arm 6B.

Further, in the multifunction peripheral 10 according to the present embodiment, the cap 6 has the hollow 64 which is open at the holding portion 63 and which extends in the extending direction of the body 61 from the holding portion 63 to the flange 62 via the body 61.

Since the cap body 6A is formed to have a hollow shape, the cap body 6A can be elastically deformed easily.

Furthermore, in the multifunction peripheral 10 according to the present embodiment, the wall portion defining the inlet port 50 is formed to have a cylindrical shape penetrating through the wall portion, partitioning the ink chamber 40 of the tank 4 from the outside of the tank 4, so as to communicate the inside and the outside of the tank 4 with each other, with the outer diameter smaller than the outer diameter of the flange 62 and the inner diameter substantially same as the outer diameter of the body 6.

With this, when the user presses, with a finger, the outer surface 62b of the flange 62 so as to push the outer surface 62b into the inlet port 50, the flange 62 is bent toward the inlet port 50, thereby releasing the tight contact between the body 61 and the cylindrical wall 43, and making it possible to deform the cap 6 such that the holding portion 63 passes through the other end portion 50b of the inlet port 50.

Further, in the multifunction peripheral 10 according to the present embodiment, both the inner circumferential surface and the outer circumferential surface of the end portion, of the wall portion defining the inlet port 50, which is configured to be exposable to the outside of the tank 4 are chamfered. Note that, however, it is allowable that at least one of these inner and outer circumferential surfaces is chamfered.

With this, the chamfered end portion of the cylindrical wall 43 is pointed to some extent. In a case that the cap 6 is to be installed in the inlet port 50, when pressing the flange 62 of the cap 6 toward the inlet port 50, the projected end portion which is pointed to some extent of the cylindrical wall 43 is stuck into the flange 62, thereby making it possible to push the holding portion 63 until the holding portion 63 reaches the ink chamber 40.

Furthermore, in the multifunction peripheral 10 according to the present embodiment, the flange 62 of the cap 6 is provided with the tab 66 (operation projection) which is projected from the outer surface 62b of the flange 62, at the position not overlapping with the opening central line L of the inlet port 50.

With this, when the user pulls and operates the tab 66 of the cap 6 which is installed in the inlet port 50, the cap 6 is pulled and elastically deformed, and the tight contact between the body 61 of the cap 6 and the surface in the cylindrical wall 43 and the inclined wall 42 defining the inlet port 50 is released gradually from the portion of the cap 6 near to the tab 66 toward other portion of the cap 6 away from the tab 66.

Moreover, in the multifunction peripheral 10 according to the present embodiment, the recording section 24 has the liquid discharge head 25 having the ink flow channel 26 (liquid flow channel) connected to the liquid outflow channel 51 of the tank 4 via the tube and the nozzles 25a configured to discharge the liquid inside the ink flow channel 26, and the liquid recovery device 16 configured to recover the liquid discharged from the nozzles 25a. Further, under the condition that the cap 6 is installed in the inlet port 50, the cap 6 has the withstanding pressure exceeding the discharging pressure of the liquid from the nozzles 25a.

With this, the pressure resistance performance of the ink chamber 40 is greater than the pressure resistance performance of the liquid discharging head 25. Accordingly, in a case that the ink chamber 40 of the tank 4 is in an over-pressure state, the ink in the ink chamber 40 of the tank 4 inflows into the liquid flow channel of the ink discharging head 25 and then the ink is discharged from the nozzles 25a, thereby resolving the over-pressure state of the ink chamber 40. The ink discharged from the nozzles 25a is recovered by the liquid recovery device 16. In such a manner, it is possible to resolve the over-pressure state in the ink chamber 40 of the tank 4 without removing the cap 6 from the inlet port 50. Therefore, any ink does not adhere to user in this operation.

As explained above, the multifunction peripheral 10 as the liquid consuming apparatus according to the embodiment includes the liquid discharging head 25 as the liquid consuming section; the tank 4 having the ink chambers 40 (liquid storing chambers) each configured to store the ink (liquid) which is to be consumed by the liquid discharging head 25, and the inlet ports 50 via each of which the ink is poured into one of the ink chambers 40; the caps 6 each configured to be detachably installable in one of the inlet ports 50 and to be capable of closing/opening the inlet port 50; and the casing 14 configured to accommodate at least a part of the liquid discharging head 25 and the tank 4. Further, each of the caps 6 has the columnar-shaped body 61 (first portion), the flange 62 (second portion) and the arm portion 6B (arm); the columnar-shaped body 61 (first portion) is located inside the inlet port 50 under a condition that the cap 6 is installed in the inlet port 50; the flange 62 (second portion) is a portion located at outside of the tank 4 under the condition that the cap 6 is installed in the inlet port 50, and is provided with the outer surface 62b which faces the outside of the tank 4 and which intersects the opening central line L of the opening of the inlet port 50 under the condition that the cap 6 is installed in the inlet port 50, the tab 66 (operation projection) which is projected from the outer surface 62b; and the arm 6B (arm) is an elastic body linking the flange 62 with the outside of the tank 4. Note that the arm 6B may link the casing 14 with the flange 62. The arm 6B is elastically deformed under the condition that the cap 6 is installed in the inlet port 50; the basal portion of the arm 6B is supported by the tank 4 so that, under the condition that the cap 6 is removed from the inlet port 50, the forward end portion of the arm 6B at which the arm 6B is connected to the flange 62 is rotated by the elastic restoration of the arm 6B about the basal portion as the rotational center. Furthermore, the casing 14 has the vertical wall 14f (wall portion) configured to make contact with (abut against) the tab 66, before making contact (abutting against) with the arm 6B and the outer surface 62b of the flange 62, in the process during which the arm 6B is rotated. Note that the vertical wall 14f may be provided on the tank 4, instead of being provided on the casing 14.

In the multifunction peripheral 10 having the above-described configuration, under the condition that the tab 66 abuts against the vertical wall 14f, the gap is defined between the vertical wall 14f and the outer surface 62b of the flange 62 of the cap 6. Accordingly, when the cap 6 is to be installed in the inlet port 50 next time, the user can insert a finger into this gap and can press and operate the outer surface 62b of the flange 62 of the cap 6. Since any liquid does not adhere to the outer surface 62b of the flange 62 of the cap 6, it is possible to suppress any adhering of the liquid to a finger of the user when the cap 6 is to be attached to the inlet port 50. Further, even in such a case that the liquid is adhered to any finger of the user, the user can suppress any adhering of liquid to the outer surface 62b of the flange 62 of the cap 6 by pressing and operating the outer surface 62b of the flange 62 of the cap 6 with a finger to which no liquid is adhered. This consequently makes it possible to suppress any adhering of the liquid to the user. Thus, according to the multifunction peripheral 10 according to the embodiment, it is possible to realize both the appropriate opening/closing of the inlet port 50 formed in the tank 4 and the improved operability during installment (attachment) of the cap 6 by the user.

Further, in the multifunction peripheral 10 according to the embodiment, the basal portion of the arm 6B is supported by the tank 4, in a state that at least the basal portion of the arm 6B assumes a standing posture in the natural state thereof, so that the forward end portion of the arm 6B is rotated upward, under the condition that the cap 6 is removed from the inlet port 50. Note that the basal portion of the arm 6B may be supported by the casing 14, instead of being supported by the tank 4.

In such a manner, the cap 6 is maintained at a location further apart from the inlet port 50. Therefore, when an operation is performed so as to pour the ink into the ink chamber 40 via the inlet port 50, the operation is not hindered by the cap 6.

Furthermore, in the multifunction peripheral 10 according to the embodiment, under the condition that the cap 6 is installed in the inlet port 50, the tab 66 is projected from the outer surface 62b of the flange 62 at a position not overlapping with the opening central line L of the inlet port 50.

With this, when the user pulls and operates the tab 66 of the cap 6 which is installed in the inlet port 50, the cap 6 is pulled and elastically deformed, and the tight contact between the body 61 of the cap 6 and the surface in the cylindrical wall 43 and the inclined wall 42 defining the inlet port 50 is released gradually from the portion of the cap 6 near to the tab 66 toward other portion of the cap 6 away from the tab 66.

At the location wherein the tight contact between the body 61 of the cap 6 and the surface in the cylindrical wall 43 and the inclined wall 42 defining the inlet port 50 has been released, the cap 6 becomes easily removable from the inlet port 50. Accordingly, the cap 6 can be pulled out from the inlet port 50 with a smaller operation load than a case wherein the sliding resistance between the cap 6 and the wall surface defining the inlet port 50 is substantially uniform along the entire circumference of the inlet port 50. Namely, it is possible to reduce the operation load when removing the cap 6 from the inlet port 50. This makes it possible to reduce the force generated when the cap 6 is pulled out from the inlet port 50, thereby making it possible to reduce the amount of the ink scattering from the cap 6. Further, since the tab 66 is projected from the location not overlapping with the opening central line L, the direction in which the user pulls the tab 66 easily intersects the opening central line L. Thus, the cap 6 is deformed so that the portion, of the cap 6, near to the tab 66 is separated from the surface defining the opening 50 and the portion in the cap 6 near to the tab 66 becomes removable from the inlet port 50 further easily, as compared with a case that the direction in which the user pulls the tab 66 is parallel to the opening central line L.

Furthermore, in the multifunction peripheral 10 according to the embodiment, in a case that the cap 6 is installed in the inlet port 50, the basal end portion of the tab 66 is located on the extension line extended from the outer edge portion of the inlet port 50 in parallel to the opening central line L of the inlet port 50.

With this, the cap 6 becomes further easily removable from the inlet port 50 firstly from a portion, of the cap 6, which is near to the tab 66.

Moreover, in the multifunction peripheral 10 according to the embodiment, under the condition that the cap 6 is installed in the inlet port 50, the tab 66 is projected from the outer surface 62b at the position shifted from the opening central line L of the inlet port 50 in the direction toward the arm 6B.

As described above, since the arm 6B is present in the vicinity of the tab 66, the user is psychologically encouraged to pull the tab 66 in a direction opposite to the arm 6B in order to avoid any interference between the tab 66 and the arm 6B. Accordingly, the direction in which the user pulls the tab 66 easily intersects the opening central line L. Thus, the portion of the cap 6 located near the tab 66 can be further easily pulled from the inlet port 50. Further, when the user pulls the cap 6 out of the inlet port 50, the head 63 to which the ink is adhered with high probability faces rearward, namely faces the side opposite to the user, thereby making it possible to suppress any scattering of the ink toward the user.

Further, in the multifunction peripheral 10 according to the embodiment, under the condition that the cap 6 is installed in the inlet port 50, the arm 6B is bent and the tab 66 is located between the bent portion of the arm 6B and the opening central line L of the inlet port 50.

With this, the user is psychologically encouraged to pull the tab 66 in a direction opposite to (away from) the bent portion of the arm 6B in order to avoid any interference between the tab 66 and the bent portion of the arm 6B. Accordingly, the direction in which the user pulls the tab 66 easily intersects the opening central line L. Thus, the portion of the cap 6 located near the tab 66 can be further easily pulled from the inlet port 50.

Furthermore, in the multifunction peripheral 10 according to the embodiment, under the condition that the cap 6 is installed in the inlet port 50, the arm 6B is connected to the tank 4 at the basal portion of the arm 6B, and the arm 6B extends upward from the basal portion, then is bent, then extends downward, and the forward end portion of the arm 6B is connected to the flange 62. Note that the basal portion of the arm 6B may be connected to the casing 14, instead of being connected to the tank 4.

With this, the user is psychologically encouraged to pull the tab 66 in the direction opposite to (away from) the bent portion of the arm 6B in order to avoid any interference between the tab 66 and the bent portion of the arm 6B. Accordingly, the direction in which the user pulls the tab 66 easily intersects the opening central line L. Thus, the portion of the cap 6 located near the tab 66 can be further easily pulled from the inlet port 50.

Furthermore, in the multifunction peripheral 10 according to the embodiment, the tab 66 has the first dimension S1 in the first direction D1 as the projection direction in which the tab 66 is projected from the outer surface 62b, the second dimension S2 in the second direction D2 orthogonal to the first direction D1, and the third dimension S3 in the third direction D3 orthogonal to the first and second directions D1 and D2, wherein the second dimension S2 is greater than the third dimension S3. Further, the tab 66 has the first surface 66a and the second surface 66b which is a reverse side of the first surface 66a. Furthermore, the first surface 66b faces the arm 6B under the condition that the tank 4 is in the pouring posture in which the ink is poured into the ink chamber 40 via the inlet port 50 and that the cap 6 is installed in the inlet port 50; and at least one catch portion (hook portion) 67 (projection or recess) is formed in the first surface 66a.

With this, when the user holds the tab 66 of the cap 6 with the fingers, the catch portion 67 catches the finger of the user, and the first surface 66a provided with the catch portion 67 is less likely to slip as compared with the second surface 66b. Accordingly, the user is induced to pull the tab 66 in a direction opposite to (away from) the arm 6B. With this, the direction in which the user pulls the tab 66 easily intersects the opening central line L. Thus, the portion, of the cap 6, located near the tab 66 can be further easily pulled from the inlet port 50.

Moreover, in the tank unit 100 according to the embodiment, the second surface 66b of the tab 66 is formed with the projection or recess of which number is smaller than that of the projection or recess formed in the first surface 66a.

With this, when the user holds the tab 66 of the cap 6 with the fingers, the first surface 66a is less likely to slip as compared with the second surface 66b.

Further, in the multifunction peripheral 10 according to the embodiment, under the condition that the tank 4 is in the pouring posture in which the ink is poured into the ink chamber 40 via the inlet port 50, the inlet port 50 is open to the outside of the tank 4 while facing obliquely upward; and the tab 66 is located above the inlet port 50 under the condition that the tank 4 is in the pouring posture and that the cap is installed in the inlet port 50.

With this, since the arm 6B which is bent (which has the bent portion) is present at the location above the tab 66, the user is psychologically encouraged to pull the tab 66 downward in order to avoid any interference between the tab 66 and the bent portion of the arm 6B. Accordingly, the direction in which the user pulls the tab 66 easily intersects the opening central line L. Thus, the portion of the cap 6 located near the tab 66 can be further easily pulled from the inlet port 50. Further, the head 63 to which the ink is adhered with high probability faces the side opposite to the user, thereby making it possible to suppress any scattering of the ink toward the user.

Further, as explained above, the tank unit 100 as the liquid storage apparatus according to the embodiment is provided with the tank 4 having the ink chamber 40 as the liquid storing chamber configured to store the liquid therein and the inlet port 50 via which the liquid is poured into the ink storing chamber 40, and the cap 6 which is detachably attached to the inlet port 50 and which is capable of opening/closing the inlet port 50. Here, the cap 6 is the elastic body constructed of an elastic material. Note that, however, it is allowable that one of the cap 6, and a portion of the cylindrical wall 43 and the inclined wall 42 which define the inlet port 50 is constructed of the elastic material. Further, the cap 6 has the columnar shaped body 61 (first portion) which is located inside the inlet port 50 under the condition that the cap 6 is installed in the inlet port 50. Furthermore, the cap 6 has the flange 62 (second portion) which is a portion located at the outside of the tank 4 under the condition that the cap 6 is installed in the inlet port 50 and which is provided with the outer surface 62b intersecting the opening central line L of the opening 50 and facing the outside of the tank 4 under the condition that the cap 6 is installed in the inlet port 50, and the tab 66 (operation projection) projected from the outer surface 62b at the location not overlapping with the opening central line L of the inlet port 50 under the condition that the cap 6 is installed in the inlet port 50.

With this, when the user pulls and operates the tab 66 of the cap 6 which is installed in the inlet port 50, the cap 6 is pulled and elastically deformed, and the tight contact between the body 61 of the cap 6 and the surface in the cylindrical wall 43 and the inclined wall 42 defining the inlet port 50 is released gradually from the portion of the cap 6 near to the tab 66 toward other portion of the cap 6 away from the tab 66.

At the location wherein the tight contact between the body 61 of the cap 6 and the surface in the cylindrical wall 43 and the inclined wall 42 defining the inlet port 50 has been released, the cap 6 becomes easily removable from the inlet port 50. Accordingly, the cap 6 can be pulled out from the inlet port 50 with a smaller operation load than a case wherein the sliding resistance between the cap 6 and the wall surface defining the inlet port 50 is substantially uniform along the entire circumference of the inlet port 50. Namely, it is possible to reduce the operation load when removing the cap 6 from the inlet port 50. This makes it possible to reduce the force generated when the cap 6 is pulled out from the inlet port 50, thereby making it possible to reduce the amount of the ink scattering from the cap 6. Further, since the tab 66 is projected from the location not overlapping with the opening central line L, the direction in which the user pulls the tab 66 easily intersects the opening central line L. Thus, the cap 6 is deformed so that the portion, of the cap 6, near to the tab 66 is separated from the surface defining the opening 50, and the portion in the cap 6 near to the tab 66 becomes removable from the inlet port 50 further easily, as compared with a case that the direction in which the user pulls the tab 66 is parallel to the opening central line L.

Further, in the tank unit 100 according to the embodiment, the basal end portion of the tab 66 is located to be nearer to the outer edge portion of the outer surface 62b of the flange 62 than the opening central line L.

With this, the cap 6 can be further easily removed from the inlet port 50 from the portion of the cap 6 near to the tab 66.

Furthermore, in the tank unit 100 according to the embodiment, the tab 66 is projected from the outer surface 62 from a portion including the outer edge portion of the outer surface 62b.

With this, the cap 6 can be further easily removed from the inlet port 50 from the portion of the cap 6 near to the tab 66.

Moreover, in the tank unit 100 according to the embodiment, the basal end portion of the tab 66 is located on the extension line extended from the outer edge portion of the inlet port 50 in parallel to the opening central line L, under the condition that the cap 6 is installed in the inlet port 50.

With this, the cap 6 can be further easily removed from the inlet port 50 from the portion of the cap 6 near to the tab 66.

Further, in the tank unit 100 according to the embodiment, in a case that the outer surface 62b of the flange 62 of the cap 6 installed in the inlet port 50 is divided into the front-side half portion A1 and the back-side half portion A2 as seen from the user operating the tab 66, the tab 66 is disposed in the back-side half portion A2 of the outer surface 62b of the flange 62 of the cap 6.

With this, when the user pulls the tab 66 of the cap 6 installed in the inlet port 50, the tight contact between the cap 6 and the wall portion defining the inlet port 50 is released in the order of nearness from the back side toward the front side as seen by the user. Accordingly, at first on the back side as seen by the user, there is generated a portion at which the cap 6 can be easily removed from the inlet port 50, and the cap 6 is removed in a stepped manner from this portion toward a side in front of the user (toward the user). With this, in the event that the ink adhered to the cap 6 scatters when the user pulls the cap 6 out of the inlet port 50, the ink can be made to scatter to the back side as seen by the user, thereby making it possible to suppress any scattering of the ink toward the user.

Furthermore, in the tank unit 100 according to the embodiment, in a case that the tab 66 is divided into a front-side half portion B1 and a back-side half portion B2 as seen from the user operating the tab 66, the catch portion 67 is formed in at least a portion of the back-side half portion B2 of the tab 66. The catch portion 67 is, for example, at least one projection or recess.

By the projection or recess formed as the catch portion 67 in at least the portion of the back-side half portion B2 of tab 66, the user is encouraged to pull the tab 66 toward the side in front of the user (toward the user).

Moreover, in the tank unit 100 according to the embodiment, the cap 6 further has the arm 6B configured to connect the flange 62 (second portion) of the cap 6 to the tank 4. In the state that the cap 6 is installed in the inlet port 50, the arm 6B is bent and tab 66 is positioned between the bent portion of the arm 6B and the opening central line L of the inlet port 50.

As described above, since the tab 66 is present between the bent portion of the arm 6B and the opening central line L, the user is psychologically encouraged to pull the tab 66 in a direction opposite to the bent portion of the arm 6B in order to avoid any interference between the tab 66 and the bent portion of the arm 6B. Accordingly, the direction in which the user pulls the tab 66 easily intersects the opening central line L. Thus, the portion of the cap 6 located near the tab 66 can be further easily pulled from the inlet port 50.

Further, in the tank unit 100 according to the embodiment, the cap 6 further has the arm 6B configured to connect the flange 62 of the cap 6 to the tank 4; under a condition that the tank 4 is in the pouring posture in which the ink is poured into the liquid storing chamber 40 via the inlet port 50, the inlet port 50 is open to outside of the tank 4 while facing obliquely upward; and under a condition that the tank 4 is in the pouring posture and that the cap 6 is installed in the inlet port 50, the tab 66 is located above the point of intersection of the outer surface 62b with the opening central line L.

With this, the user is psychologically encouraged to pull the tab 66 further downward, and the direction in which the user pulls the tab 66 easily intersects the opening central line L. Thus, the portion of the cap 6 located near the tab 66 can be further easily pulled from the inlet port 50. Further, the head 63 to which the ink is adhered with high probability faces the side opposite to the user, thereby making it possible to suppress any scattering of the ink toward the user.

Furthermore, in the tank unit 100 according to the embodiment, the tab 66 has the first dimension S1 in the first direction D1 as the projection direction in which the tab 66 is projected from the outer surface 62b, the second dimension S2 in the second direction D2 orthogonal to the first direction D1, and the third dimension S3 in the third direction D3 orthogonal to the first and second directions D1 and D2, wherein the second dimension S2 is greater than the third dimension S3. Further, the tab 66 has the first surface 66a and the second surface 66b that is a reverse side of the first surface 66a. Furthermore, under the condition that the tank 4 is in the pouring posture and that the cap 6 is installed in the inlet port 50, the second direction D2 is substantially coincident with the horizontal direction and the first surface 66a is located above the second surface 66b; and further at least one catch portion (projection or recess) 67 is formed in the first surface 66a.

With this, the user touches the first surface 66a of the tab 66 with a finger from thereabove, and touches the second surface 66b of the tab 66 with another finger from therebelow, thereby holding the tab 66 of the cap 6 with the two fingers. When the user holds the tab 66 of the cap 6 with the fingers, the catch portion 67 catches the finger, and the first surface 66a provided with the catch portion 67 is less likely to slip as compared with the second surface 66b. Accordingly, the user is psychologically encouraged to pull the tab 66 toward further downward. With this, the direction in which the user pulls the tab 66 easily intersects the opening central line L. Thus, the portion, of the cap 6, located near the tab 66 can be further easily pulled from the inlet port 50. Further, the head 63 to which the ink is adhered with high probability faces the side opposite to the user, thereby making it possible to suppress any scattering of the ink toward the user.

Moreover, in the tank unit 100 according to the embodiment, the second surface 66b of the tab 66 is formed with the projection or recess of which number is smaller than that of the projection or recess formed in the first surface 66a.

With this, when the user holds the tab 66 of the cap 6 with the fingers, the first surface 66a is less likely to slip as compared with the second surface 66b.

Further, in the tank unit 100 according to the embodiment, under the condition that the tank 4 is in the pouring posture and that the cap 6 is installed in the inlet port 50, the art 6B is connected to the tank 4 at the basal portion of the arm 6B, and the arm 6B extends upward from the basal portion, then is bent, then extends downward, and is connected to the flange 62 at the forward end portion of the arm 6B.

With this, since the bent arm 6B is present at the location above the tab 66, the user is psychologically encouraged to pull the tab 66 further downward in order to avoid any interference between the tab 66 and the bent portion of the arm 6B. Accordingly, the direction in which the user pulls the tab 66 easily intersects the opening central line L. Thus, the portion of the cap 6 located near the tab 66 can be further easily pulled from the inlet port 50. Further, the head 63 to which the ink is adhered with high probability faces the side opposite to the user, thereby making it possible to suppress any scattering of the ink toward the user.

Furthermore, in the tank unit 100 according to the embodiment, the cap 6 further has the arm 6B configured to connect the flange 62 of the cap 6 to the tank 4; the basal portion of the arm 6B is connected to the tank 4, and the forward end portion of the arm 6B is connected to the peripheral portion of the flange 62; and under the condition that the cap 6 is installed in the inlet port 50, the tab 66 is projected at a position shifted closer to the arm 6B than the opening central line L.

With this, the user is psychologically encouraged to pull the tab 66 in a direction opposite to (away from) the arm 6B in order to avoid any interference between the tab 66 and the bent portion of the arm 6B. Accordingly, the direction in which the user pulls the tab 66 easily intersects the opening central line L. Thus, the portion of the cap 6 located near the tab 66 can be further easily pulled from the inlet port 50.

Moreover, in the tank unit 100 according to the embodiment, the tab 66 has the first dimension S1 in the first direction D1 as the projection direction in which the tab 66 is projected from the outer surface 62b, the second dimension S2 in the second direction D2 orthogonal to the first direction D1, and the third dimension S3 in the third direction D3 orthogonal to the first and second directions D1 and D2, wherein the second dimension S2 is greater than the third dimension S3. Further, the tab 66 has the first surface 66a and the second surface 66b that is a reverse side of the first surface 66a. Furthermore, under the condition that the cap 6 is installed in the inlet port 50, the first surface 66a faces (is oriented to face toward) the arm 6B; and at least one catch portion (projection or recess) 67 is formed in the first surface 66a.

With this, when the user holds the tab 66 of the cap 6 with the fingers, the catch portion 67 catches the finger, and the first surface 66a provided with the catch portion 67 is less likely to slip as compared with the second surface 66b. Accordingly, the user is psychologically encouraged to pull the tab 66 further in a direction opposite to (away from) the arm 6B. With this, the direction in which the user pulls the tab 66 easily intersects the opening central line L. Thus, the portion, of the cap 6, located near the tab 66 can be further easily pulled from the inlet port 50.

Further, in the tank unit 100 according to the embodiment, the second surface 66b of the tab 66 is formed with the projection or recess of which number is smaller than that of the projection or recess formed in the first surface 66a.

With this, when the user holds the tab 66 of the cap 6 with the fingers, the first surface 66a is less likely to slip as compared with the second surface 66b.

Furthermore, in the tank unit 100 according to the embodiment, the arm 6B is formed of an elastic material so that the arm 6B is bendable under the condition that the cap 6 is installed in the inlet port 50 and that the arm 6B is elastically recoverable to mitigate an extent of bending of the arm 6B under a condition that the cap 6 is not installed in the inlet port 50.

With this, when the cap 6 is removed from the inlet port 50, the cap 6 is away from the inlet port 50 by the elastic recovery of the arm 6B, thus allowing the cap 6 to be maintained at a position away from the inlet port 50. Therefore, when an operation is performed so as to pour the ink into the ink chamber 40 from the inlet port 50, the operation is not hindered by the cap 6.

Moreover, in the tank unit 100 according to the embodiment, the basal portion of the arm 6B is connected to the outside of the tank 4 such that at least the basal portion of the arm 6B stands up under a condition that the arm 6B is in a natural state.

With this, the cap 6 is maintained at a position further away from the inlet port 50.

Further, the multifunction peripheral 10 as the liquid consuming apparatus according to the embodiment includes: the tank unit 100 as the liquid storage apparatus; the liquid discharging head 25 as the liquid consuming section configured to consumed an ink (liquid) stored in the tank unit 100; and the casing 14 configured to accommodate at least a part of the liquid discharging head 25 and the tank unit 100, wherein the casing 14 has the vertical wall 14f (wall portion) configured to make contact with (abut against) the tab 66, before making contact (abutting against) with the arm 6B and the outer surface 62b of the flange 62, under a condition that the arm 6B of the cap 6 undergoes elastic recovery. The vertical wall 14f may be disposed on the tank 4, rather than on the casing 14.

As described above, the tab 66, of the cap 6, which projects from the flange 62 abuts against (makes contact with) the vertical wall 14f of the casing 14, thereby forming a gap between the vertical wall 14f of the casing 14 and the outer surface 62b of the flange 62 of the cap 6. By employing this gap between the vertical wall 14f of the casing 14 and the outer surface 62b of the flange 62 so as to insert a finger into the gap, the user can operate the flange 62 (cap 6) without dirtying or staining the finger(s) with the ink.

As explained above, the tank unit 100 as the liquid storage apparatus according to the embodiment is provided with the tank 4 having the ink chamber 40 as the liquid storing chamber configured to store the liquid therein and the inlet port 50 via which the liquid is poured into the ink storing chamber 40, and the cap 6 which is detachably attached to the inlet port 50 and which is capable of opening/closing the inlet port 50. Here, the cap 6 is the elastic body constructed of an elastic material. Note that, however, it is allowable that one of the cap 6, and a portion of the cylindrical wall 43 and the inclined wall 42 which define the inlet port 50 is constructed of the elastic material.

Further, the cap 6 has the columnar shaped body 61 (first portion) which is located inside the inlet port 50 under the condition that the cap 6 is installed in the inlet port 50. Furthermore, the cap 6 has the flange 62 (second portion) which is the portion located at the outside of the tank 4 under the condition that the cap 6 is installed in the inlet port 50, and which is provided with the outer surface 62b facing the outside of the tank 4 and the tab 66 (operation projection) projected from the outer surface 62b. Furthermore, the tab 66 has the first surface 66a forming a portion of the outer circumferential surface of the tab 66 and the second surface 66b which is a reverse side of the first surface 66a; and the catch portion (hook portion) 67 is formed in the first surface 66a of the tab 66. The catch portion 67 is formed as at least one projection, or as at least one recess.

In the tank unit 100 having the above-described configuration, when the user operates the tab 66 disposed in the cap 6, the user holds the tab 66 with two fingers by placing the inner surfaces of the two fingers respectively on the first and second surfaces 66a and 66b of the tab 66, and pulls the tab 66 held between the two fingers. Here, the first surface 66a, of the tab 66, provided with the catch portion 67 such as the projection or recess is caught by the user's finger more easily than the second surface 66b of the tab 66. Therefore, the user is encouraged to pull the tab 66 in a direction for pulling down (lowering) the tab 66 toward the side of the second surface 66b. Namely, the user is encouraged to pull the tab 66 in a direction (in the embodiment, the direction crossing the opening central line L) for allowing the surface, of the cap 6, which faces a direction that is same as the direction in which the first surface 66a of the tab 66 faces to be firstly removed from the surface in the cylindrical wall 43 and the inclined wall 42 defining the inlet port 50. With this, the tight contact between the cap 6 (in particular, the body 61 of the cap 6) and the surface in the cylindrical wall 43 and the inclined wall 42 defining the inlet port 50 is released firstly from the surface, among the cap 6, which faces the direction same as the direction in which the first surface 66a of the tab 66 faces.

At the location wherein the tight contact between the body 61 of the cap 6 and the wall surface forming the inlet port 50 has been released, the cap 6 becomes easily removable from the inlet port 50. Accordingly, the cap 6 can be pulled out from the inlet port 50 with a smaller operation load than a case wherein the sliding resistance between the cap 6 and the wall surface defining the inlet port 50 is substantially uniform along the entire circumference of the inlet port 50. Namely, it is possible to reduce the operation load when removing the cap 6 from the inlet port 50. This makes it possible to reduce the force generated when the cap 6 is pulled out from the inlet port 50, thereby making it possible to reduce the amount of the ink scattering from the cap 6.

Further, in the tank unit 100 according to the embodiment, in a case that the tab 66 of the cap 6 installed in the inlet port 50 is divided into a front-side half portion B1 and a back-side half portion B2 as seen from the user operating the tab 66, the first surface 66a is formed in the back-side half portion B2, and the second surface 66b is formed in the front-side half portion B1.

With this, when the user pulls the tab 66 of the cap 6 installed in the inlet port 50, the tight contact between the cap 6 and the wall portion defining the inlet port 50 is released in the order of nearness from the back side toward the front side as seen by the user. Accordingly, at first on the back side as seen by the user, there is generated a portion at which the cap 6 can be easily removed from the inlet port 50, and the cap 6 is removed in a stepped manner from this location toward a side in front of the user (toward the user). With this, in the event that the ink adhered to the cap 6 scatters when the user pulls the cap 6 out of the inlet port 50, the ink can be made to scatter to the back side as seen by the user, thereby making it possible to suppress any scattering of the ink toward the user.

Furthermore, in the tank unit 100 according to the embodiment, in a case that the cap 6 is installed in the inlet port 50, the tab 66 is projected from the outer surface 62b at the position shifted from the opening central line L in the direction in which the first surface 66a faces.

With this, the direction in which the user pulls the tab 66 is the direction for pulling down (lowering) the tab 66 toward the side of the second surface 66b of the tab 66, thereby making the pulling direction to be crossable the opening central line L further easily. With this, the cap 6 becomes further easily removable from the inlet port 50 firstly from the surface, of the cap 6, which faces the direction that is same as the direction in which the first surface 66a of the tab 66 faces.

Moreover, in the tank unit 100 according to the embodiment, under the condition that the cap 6 is installed in the inlet port 50, the basal end portion of the tab 66 is located on the extension line extended from the outer edge portion of the inlet port 50 in parallel to the opening central line L.

With this, the cap 6 becomes further easily removable from the inlet port 50 firstly from the surface, of the cap 6, which faces the direction that is same as the direction in which the first surface 66a of the tab 66 faces.

Furthermore, in the tank unit 100 according to the embodiment, the tab 66 has the first dimension S1 in the first direction D1 as the projection direction in which the tab 66 is projected from the outer surface 62b, the second dimension S2 in the second direction D2 orthogonal to the first direction D1, and the third dimension S3 in the third direction D3 orthogonal to the first and second directions D1 and D2, wherein the second dimension S2 is greater than the third dimension S3. Further, the first surface 66a and the second surface 66b of the tab 66 face mutually opposite directions which are parallel to the third direction D3.

Such a dimensional relationship makes it easier for the user to hold the tab 66 with two fingers by placing the inner surfaces of the two fingers respectively on the first and second surfaces 66a and 66b of the tab 66.

Moreover, in the tank unit 100 according to the embodiment, the second surface 66b of the tab 66 is formed with the projection or recess of which number is smaller than that of the projection or recess formed in the first surface 66a.

With this, when the user holds the tab 66 of the cap 6 with the fingers, the first surface 66a is less likely to slip, namely is easier to catch, as compared with the second surface 66b.

Further, in the tank unit 100 according to the embodiment, under the condition that the cap 6 is installed in the inlet port 50, the outer surface 62b of the flange 62 of the cap 6 crosses (intersects) the opening central line L of the inlet port 50, and the basal end portion of the tab 66 is located on the outer surface 62b at the position which is shifted from the opening central line L in the direction in which the first surface 66a faces, and which is near to the outer edge portion of the outer surface 62b than the opening central line L.

With this, the direction in which the user pulls the tab 66 is the direction for pulling down (lowering) the tab 66 toward the side of the second surface 66b of the tab 66, thereby making the pulling direction to be crossable the opening central line L further easily. With this, the cap 6 becomes further easily removable from the inlet port 50 firstly from the surface, of the cap 6, which faces the direction that is same as the direction in which the first surface 66a of the tab 66 faces.

Furthermore, in the tank unit 100 according to the embodiment, the tab 66 is projected from the portion, in the outer surface 62b, including the outer edge portion of the outer surface 62b.

With this, the cap 6 becomes further easily removable from the inlet port 50 firstly from the surface, of the cap 6, which faces the direction that is same as the direction in which the first surface 66a of the tab 66 faces.

Moreover, in the tank unit 100 according to the embodiment, the cap 6 further has the arm 6B configured to connect the flange 62 (second portion) of the cap 6 to the tank 4. In the state that the cap 6 is installed in the inlet port 50, the arm 6B is bent and tab 66 is positioned between the bent portion of the arm 6B and the opening central line L of the inlet port 50, and the first surface 66a of the tab 66 and the arm 6B face each other.

With this, the user is psychologically encouraged to pull the tab 66 in a direction on the side opposite to the arm 6B, namely in the direction for pulling down (lowering) the tab 66 further toward the side of the second surface 66b of the tab 66 in order to avoid any interference between the tab 66 and the bent portion of the arm 6B, thereby making the pulling direction to be easily crossable the opening central line L. Accordingly, the cap 6 becomes further easily removable from the inlet port 50 firstly from the surface, of the cap 6, which faces the direction that is same as the direction in which the first surface 66a of the tab 66 faces.

Further, in the tank unit 100 according to the embodiment, the arm 6B is formed of an elastic material so that the arm 6B is bendable under the condition that the cap 6 is installed in the inlet port 50, and is elastically recoverable to mitigate an extent of bending of the arm 6B under a condition that the cap 6 is not installed in the inlet port 50.

With this, when the cap 6 is removed from the inlet port 50, the cap 6 is away from the inlet port 50 by the elastic recovery of the arm 6B, thus allowing the cap 6 to be maintained at a position away from the inlet port 50. Therefore, when an operation is performed so as to pour the ink into the ink chamber 40 from the inlet port 50, the operation is not hindered by the cap 6.

Moreover, in the tank unit 100 according to the embodiment, the basal portion of the arm 6B is connected to the outside of the tank 4 such that at least the basal portion of the arm 6B stands up under a condition that the arm 6B is in a natural state.

With this, the cap 6 is maintained at a position away from the inlet port 50.

Further, in the tank unit 100 according to the embodiment, the basal portion of the arm 6B is connected to the tank 4 at the location above the inlet port 50; under the condition that the tank 4 is in the pouring posture, the inlet port 50 is open to the outside of the tank 4 while facing obliquely upward; and under the condition that the tank 4 is in the pouring posture and that the cap 6 is installed in the inlet port 50, the tab 66 is located above the opening central line L of the inlet port 50.

With this, since the tab 66 is located above the opening central line L of the inlet port 50 and the arm 6B is located above the tab 66, the user is psychologically encouraged to pull the tab 66 further downward, namely, further in the direction for pulling down (lowering) the tab 66 toward the side of the second surface 66b of the tab 66, in order to avoid any interference between the tab 66 and the bent portion of the arm 6B. This makes the direction in which the user pulls the tab 66 to be easily crossable the opening central line L. Accordingly, the cap 6 becomes further easily removable from the inlet port 50 firstly from the surface, of the cap 6, which faces the direction that is same as the direction in which the first surface 66a of the tab 66 faces.

Furthermore, the multifunction peripheral 10 as the liquid consuming apparatus according to the embodiment includes: the tank unit 100 as the liquid storage apparatus; the liquid discharging head 25 as the liquid consuming section configured to consumed an ink (liquid) stored in the tank unit 100; and the casing 14 configured to accommodate at least a part of the liquid discharging head 25 and the tank unit 100, wherein the casing 14 has the vertical wall 14f (wall portion) configured to make contact with (abut against) the tab 66, before making contact with (abutting against) the arm 6B and the outer surface 62b of the flange 62, under a condition that the arm 6B of the cap 6 undergoes elastic recovery. The vertical wall 14f may be disposed on the tank 4, rather than on the casing 14.

As described above, the tab 66, of the cap 6, projecting from the flange 62 abuts against (makes contact with) the vertical wall 14f of the casing 14, thereby forming a gap between the vertical wall 14f of the casing 14 and the outer surface 62b of the flange 62 of the cap 6. By employing this gap between the vertical wall 14f of the casing 14 and the outer surface 62b of the flange 62 so as to insert a finger into the gap, the user can operate the flange 62 (cap 6) without dirtying or staining the finger(s) with the ink.

The preferred embodiment of the present teaching has been explained as above. However, the configuration described above can be modified as follows.

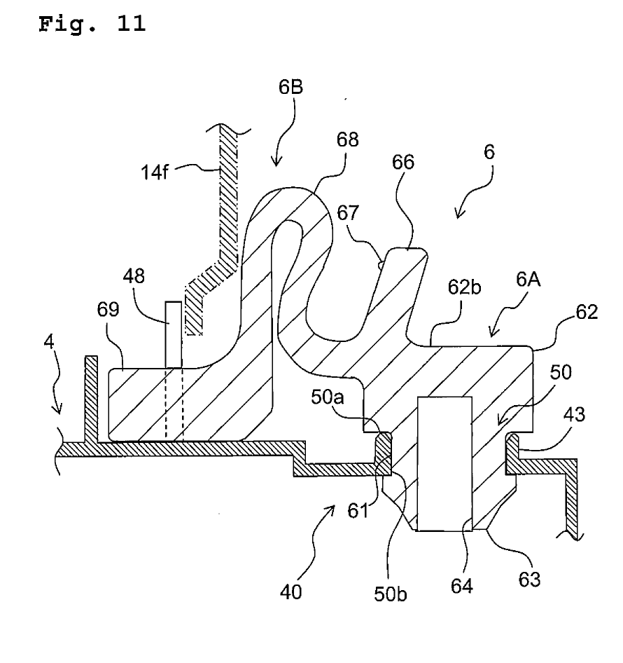

For example, in the multifunction peripheral 10 according to the above-described embodiment and in the tank unit 100 according to the present embodiment, under the condition that the tank 4 is in the pouring posture, the inlet port 50 is open while facing obliquely upward, namely is open while facing frontward and upward. However, the direction of opening of the inlet port 50 is not limited to that in the embodiment. For example, as depicted in FIG. 11, under the condition that the tank 4 is in the pouring posture, the inlet port 50 may be open while facing upward. In this case, when the cap 6 is installed in the inlet port 50, it is desirable that the tab 66 formed on the outer surface 62b of the flange 62 of the cap 6 is projected from the outer surface 62b of the flange 62 obliquely upward, namely frontward and upward. With this, the user can hold the tab 66 easily from the front side.

Further, for example, in the multifunction peripheral 10 according to the above-described embodiment and in the tank unit 100 according to the present embodiment, the cap 6 is composed of an elastic material which is elastically deformable, and the cap 6 is attached to and detached from the inlet port 50 by the elastic deformation of the cap 6. Note that, however, it is allowable that the cap body 6A of the cap 6 is formed of a hardly deformable material (for example, hard resin, etc.); the wall portion defining the inlet port 50 (namely, the cylindrical wall 43 and the portion of the inclined wall 42 which define the inlet port 50) may be composed of an elastic material which is elastically deformable, and the wall portion forming the inlet port 50 may be elastically deformed to thereby allow the cap 6 to be attached to and detached from (installed/removed with respect to) the inlet port 50.

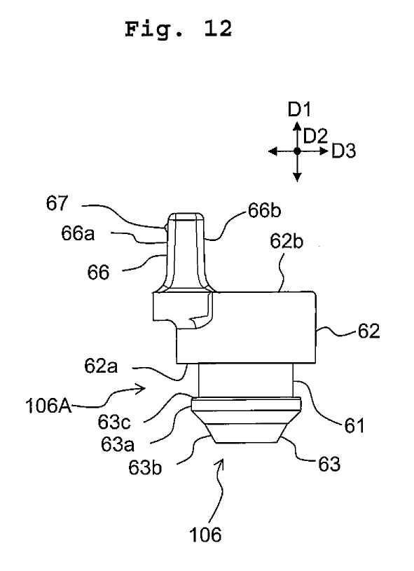

Furthermore, although the cap body 6A and the arm 6B of the cap 6 are integrally formed in the multifunction peripheral 10 according to the present embodiment, it is allowable that the cap body 6A and the arm 6B are molded as separate bodies and are joined to each other. Alternatively, the cap 106 may not include the arm but may only include the cap body 106A, as depicted in FIG. 12. The cap body 106A depicted in FIG. 12 is same as the cap body 6A depicted in FIG. 7. Therefore, the same reference signs are assigned to the components identical in configuration to those depicted in FIG. 7, and any explanation therefor are omitted.

From the above explanation, numerous improvements and/or other modifications of the present teaching will be apparent to a person skilled in the art. Accordingly, the above explanation should be interpreted only as an example and as being provided for the purpose of teaching the best mode for carrying out the present teaching to the person skilled in the art. The configuration and/or the detailed function of the present teaching can be substantially changed, without departing from the spirit and/or gist of the present teaching.

Next, a related teaching which is related closely to the present teaching will be explained.

According to a first aspect of the related teaching, there is provided a liquid consuming apparatus including:

a liquid consuming section;

a tank having a liquid storing chamber storing a liquid which is to be consumed by the liquid consuming section, and an inlet port which is formed to penetrate through a wall portion, of the tank, partitioning the liquid storing chamber from outside of the liquid storing chamber, and via which the liquid is poured into the liquid storing chamber;

a cap which is detachably installed in the inlet port and which is capable of closing/opening the inlet port; and

a casing which accommodates at least a part of the liquid consuming section and the tank,

wherein one of the cap and the wall portion, of the tank, defining the inlet port is formed of an elastic material;

the cap has: a columnar-shaped first portion which is located inside the inlet port under a condition that the cap is installed in the inlet port; a second portion which is a portion located at inside of the tank under the condition that the cap is installed in the inlet port and which is provided with a first nip surface continued to a forward end portion of the first portion; and a third portion which is a portion located at outside of the tank under the condition that the cap is installed in the inlet port, and which is provided with an outer surface facing the outside of the tank, and a second nip surface continued to a basal end portion of the first portion and facing the first nip surface;

outer diameters of the first and second nip surfaces are greater than an inner diameter of the inlet port, and a length of the first portion in an extending direction of the first portion is shorter than a length, in an extending direction of an opening central line of an opening of the inlet port, of the wall portion defining the inlet port; and

one of the cap and the wall portion defining the inlet port of the tank is elastically deformed, under the condition that the cap is installed in the inlet port, so that a length between the first and second nip surfaces in the extending direction of the opening central line of the opening of the inlet port becomes substantially same as the length, in the extending direction of the opening central line of the opening of the inlet port, of the wall portion defining the inlet port.

In the liquid consuming apparatus of the first aspect, the second portion may have a basal end portion of which outer diameter is greater than that of the first portion, and a forward end portion which is a portion inserted into the inlet port firstly among the cap, and of which outer diameter is decreased from the basal end portion toward a tip of the forward end portion until the outer diameter thereof becomes smaller than the inner diameter of the inlet port.

In the liquid consuming apparatus of the first aspect, the cap may further have an arm linking the outside of the tank and the third portion; and

under the condition that the cap is installed in the inlet port, the arm may be bent by elastic deformation.

In the liquid consuming apparatus of the first aspect, the cap may have a hollow which is open at the second portion and which extends in the extending direction of the first portion from the second portion into the third portion via the first portion.

In the liquid consuming apparatus of the first aspect, the wall portion defining the inlet port may have an outer diameter smaller than an outer diameter of the third portion, and an inner diameter substantially same as an outer diameter of the first portion, and may be formed to have a cylindrical shape penetrating through the wall portion, partitioning the liquid storing chamber of the tank from the outside of the liquid storing chamber, so as to communicate the inside and the outside of the tank with each other. Further, at least one of an inner circumferential surface and an outer circumferential surface of an end portion, of the wall portion defining the inlet port, which is exposable to the outside of the tank, may be chamfered.

In the liquid consuming apparatus of the first aspect, the third portion may be provided with an operation projection which is projected from the outer surface of the third portion, at a position not overlapping with the opening central line of the opening of the inlet port.

In the liquid consuming apparatus of the first aspect, the liquid consuming section may have a liquid discharge head having a liquid flow channel connected to a liquid outflow channel of the tank via a tube and a nozzle which discharges the liquid inside the liquid flow channel, and a liquid recovery device which recovers the liquid discharged from the nozzle; and

under the condition that the cap is installed in the inlet port, the cap may have a withstanding pressure exceeding a discharging pressure of the liquid from the nozzle.

According to a second aspect of the related teaching, there is provided a liquid consuming apparatus including:

a liquid consuming section;

a tank having a liquid storing chamber storing a liquid which is to be consumed by the liquid consuming section, and an inlet port via which the liquid is poured into the liquid storing chamber;

a cap which is detachably installed in the inlet port and which is capable of closing/opening the inlet port; and

a casing which accommodates at least a part of the liquid consuming section and the tank,

wherein the cap has: a columnar-shaped first portion which is located inside the inlet port under a condition that the cap is installed in the inlet port; a second portion which is a portion located at outside of the tank under the condition that the cap is installed in the inlet port, and which is provided with an outer surface facing the outside of the tank and intersecting an opening central line of an opening of the inlet port under the condition that the cap is installed in the inlet port, and an operation projection projected from the outer surface; and an arm which is an elastic body linking the second portion with the tank or the casing;

the arm is elastically deformed under the condition that the cap is installed in the inlet port;

a basal portion of the arm is supported by the tank or the casing so that, under a condition that the cap is removed from the inlet port, a forward end portion of the arm at which the arm is connected to the second portion is rotated by an elastic restoration of the arm about the basal portion as a rotational center;

the casing or the tank has a wall portion which makes contact with (abuts against) the operation projection, before making contact with (abutting against) the arm and the outer surface of the second portion, in a process during which the arm is rotated.

In the liquid consuming apparatus of the second aspect of the related teaching, under a condition that the operation projection abuts against the wall portion, a gap is defined between the wall portion and the outer surface of the second portion of the cap. Accordingly, when the cap is to be installed in the inlet port next time, the user can insert a finger into this gap and can press and operate the outer surface of the second portion of the cap. Since any liquid does not adhere to the outer surface of the second portion of the cap, it is possible to suppress any adhering of the liquid to a finger of the user when the cap is to be attached to the inlet port. Further, even in such a case that the liquid is adhered to any finger of the user, the user can suppress any adhering of liquid to the outer surface of the second portion of the cap by pressing and operating the outer surface of the second portion of the cap with a finger to which no liquid is adhered. This consequently makes it possible to suppress any adhering of the liquid to the user.

According to the liquid consuming apparatus of the second aspect of the related teaching, it is possible to provide a liquid consuming apparatus provided with a cap capable of realizing both the appropriate opening/closing of an inlet port formed in a tank and the improved operability during attachment of the cap by an user.

In the liquid consuming apparatus of the second aspect, the basal portion of the arm may be supported by the tank or the casing, in a state that at least the basal portion of the arm assumes a standing posture in a natural state thereof, so that the forward end portion of the arm is rotated upward under the condition that the cap is removed from the inlet port.

In the liquid consuming apparatus of the second aspect, under the condition that the cap is installed in the inlet port, the operation projection may be projected from the outer surface at a position not overlapping with the opening central line of the opening of the inlet port.

In the liquid consuming apparatus of the second aspect, under the condition that the cap is installed in the inlet port, a basal end portion of the operation projection may be located on an extension line extended from an outer edge portion of the inlet port in parallel to the opening central line of the opening of the inlet port.

In the liquid consuming apparatus of the second aspect, under the condition that the cap is installed in the inlet port, the operation projection may be projected from the outer surface at a position shifted from the opening central line of the opening of the inlet port in a direction toward the arm.

In the liquid consuming apparatus of the second aspect, under the condition that the cap is installed in the inlet port, the arm may be bent and the operation projection may be located between a bent portion of the arm and the opening central line of the opening of the inlet port.

Further, under the condition that the cap is installed in the inlet port, the arm may be connected to the tank or the casing at the basal portion of the arm, and the arm may extend upward from the basal portion, then may be bent, then may extend downward, and the forward end portion of the arm may be connected to the second portion.

Furthermore, the operation projection may have a first dimension in a first direction as a projection direction in which the operation projection is projected from the outer surface, a second dimension in a second direction orthogonal to the first direction, and a third dimension smaller than the second dimension in a third direction orthogonal to the first and second directions;

the operation projection may have a first surface and a second surface which is a reverse side of the first surface;

the first surface may face the arm under a condition that the cap is installed in the inlet port; and

at least one projection or recess may be formed in the first surface.

Moreover, the second surface may be formed with a projection or recess of which number is smaller than a number of the projection or recess formed in the first surface.

In the liquid consuming apparatus of the second aspect, under the condition that the cap is installed in the inlet port, the operation projection may be projected from the outer surface at a position shifted from the opening central line of the opening of the inlet port in a direction toward the arm; and

further, the inlet port may be open to the outside of the tank while facing obliquely upward; and the basal portion of the arm may be located above the inlet port.

According to a third aspect of the related teaching, there is provided a liquid storage apparatus including:

a tank having a liquid storing chamber configured to store a liquid, and an inlet port; and

a cap which is detachably installed in the inlet port,

wherein one of the cap and a wall portion, of the tank, defining the inlet port is formed of an elastic material;

the cap includes: a first portion; and a second portion which is provided with an outer surface intersecting an opening central line of an opening of the inlet port; and an operation projection projected from the outer surface, and

the cap is configured to be installed to the inlet port so that the first portion is located inside the inlet port, the second portion is located at outside of the tank and faces the outside of the tank, and the operation projection is projected from the outer surface at a location not overlapping with the opening central line of the inlet port.

In the liquid storage apparatus of the third aspect of the related teaching, the operation projection is projected at the position not overlapping with the opening central line of the inlet port. Therefore, when the user operates the operation projection by pulling the operation projection, the portion of the cap located in the vicinity of the operation projection can be pulled out from the inlet port more easily as compared with other portion of the cap different from the portion in the vicinity of the operation projection. As a result, the operation load of the user when removing the cap from the inlet port can be reduced.

According to the liquid storage apparatus of the third aspect of the related teaching, it is possible to provide a liquid storage apparatus provided with a cap capable of realizing both the appropriate opening/closing of an inlet port formed in a tank and the improved operability during removing of the cap by an user, and to provide a liquid consuming apparatus provided with the liquid storage apparatus.

In the liquid storage apparatus of the third aspect, under the condition that the cap is installed in the inlet port, a basal end portion of the operation projection may be located closer to an outer edge portion of the outer surface than the opening central line.

In the liquid storage apparatus of the third aspect, the operation projection may be projected from a portion, in the outer surface, including the outer edge portion of the outer surface.

In the liquid storage apparatus of the third aspect, under the condition that the cap is installed in the inlet port, a basal end portion of the operation projection may be located on an extension line extended from an outer edge portion of the inlet port in parallel to the opening central line.

In the liquid storage apparatus of the third aspect, the operation projection may be arranged at a rear-side of the opening central line in a front-rear direction of the liquid storage apparatus.

In the liquid storage apparatus of the third aspect, a projection or recess may be formed on the rear-side of the operation projection, the projection or recess projecting or recessed in a direction intersecting a projection direction in which the operation projection is projected from the outer surface.

In the liquid storage apparatus of the third aspect, the cap may further have an arm linking the tank and the second portion of the cap; and

under the condition that the cap is installed in the inlet port, the arm may be bent and the operation projection may be located between a bent portion of the arm and the opening central line.

In the liquid storage apparatus of the third aspect, the cap may further have an arm linking the tank and the second portion of the cap;

the inlet port may be open to the outside of the tank while facing obliquely upward; and

under a condition that the cap is installed in the inlet port, the operation projection may be located above a point of intersection of the outer surface with the opening central line of the opening of the inlet port.

In the liquid storage apparatus of the third aspect, the operation projection may have a first dimension in a first direction as a projection direction in which the operation projection is projected from the outer surface, a second dimension in a second direction orthogonal to the first direction, and a third dimension smaller than the second dimension in a third direction orthogonal to the first and second directions;

the operation projection may have a first surface and a second surface which is a reverse side of the first surface;

under the condition that the cap is installed in the inlet port, the second direction may be substantially coincident with a horizontal direction and the first surface may be located above the second surface; and

at least one projection or recess may be formed in the first surface.

Further, the second surface may be formed with a projection or recess of which number is smaller than a number of the projection or recess formed in the first surface.

Furthermore, under the condition that the cap is installed in the inlet port, the arm may be connected to the tank at a basal portion of the arm at a position above the inlet port, the arm may extend upward from the basal portion, then may be bent, then may extend downward, and may be connected to the second portion at a forward end portion of the arm.

In the liquid storage apparatus of the third aspect, the cap may further have an arm linking the tank and the second portion of the cap;

a basal portion of the arm may be connected to the tank, and a forward end portion of the arm may be connected to a peripheral portion of the second portion; and

under the condition that the cap is installed in the inlet port, the operation projection may be projected from the outer surface at a position shifted closer to the arm than the opening central line.

Further, the operation projection may have a first dimension in a first direction as a projection direction in which the operation projection is projected from the outer surface, a second dimension in a second direction orthogonal to the first direction, and a third dimension smaller than the second dimension in a third direction orthogonal to the first and second directions;

the operation projection may have a first surface and a second surface which is a reverse side of the first surface;

under the condition that the cap is installed in the inlet port, the first surface may face toward the arm; and

at least one projection or recess may be formed in the first surface.

Furthermore, the second surface may be formed with a projection or recess of which number is smaller than a number of the projection or recess formed in the first surface.

In the liquid storage apparatus of the third aspect, the cap may further have an arm linking the tank and the second portion of the cap;

a basal portion of the arm may be connected to the tank, and a forward end portion of the arm may be connected to a peripheral portion of the second portion;

under the condition that the cap is installed in the inlet port, the operation projection may be projected from the outer surface at a position shifted closer to the arm than the opening central line; and

further, the arm may be formed of an elastic material so that the arm is elastically recoverable to mitigate an extent of bending of the arm under a condition that the cap is not installed in the inlet port.

Furthermore, the basal portion of the arm may be connected to the tank so that at least the basal portion of the arm stands up under a condition that the arm is in a natural state.

According to a fourth aspect of the related teaching, there is provided a liquid consuming apparatus including:

the liquid storage apparatus of the third aspect of the related teaching;

a liquid consuming section which consumes a liquid stored in the liquid storage apparatus; and

a casing which accommodates at least a part of the liquid consuming section and the liquid storage apparatus.

According to a fifth aspect of the related teaching, there is provided a liquid consuming apparatus including:

the liquid storage apparatus of the third aspect of the related teaching;

a liquid consuming section which consumes a liquid stored in the liquid storage apparatus; and

a casing which accommodates at least a part of the liquid consuming section and the liquid storage apparatus,

wherein the casing has a wall portion which makes contact with (abuts against) the operation projection, before making contact with (abutting against) the arm and the outer surface, under a condition that the arm undergoes elastic recovery.

According to a sixth aspect of the related teaching, there is provided a liquid storage apparatus including:

a tank having a liquid storing chamber which is configured to store a liquid, and an inlet port; and

a cap which is configured to be detachably installable in the inlet port,

wherein one of the cap and a wall portion, of the tank, defining the inlet port is formed of an elastic material;

the cap includes: a first portion; and a second portion which is provided with an outer surface facing the outside of the tank, and an operation projection projected from the outer surface;

the cap is configured to be installed to the inlet port so that the first portion is located inside the inlet port, and the second portion is inserted into the tank through the inlet port,

wherein the operation projection has a first surface forming a portion of an outer circumferential surface of the operation projection and a second surface which is a reverse side of the first surface; and

at least one projection or recess is formed in the first surface.

In the liquid storage apparatus of the sixth aspect of the related teaching, when the user operates the operation projection disposed in the cap, the user holds the operation projection with two fingers by placing the inner surfaces of the two fingers respectively on the first and second surfaces of the operation projection, and pulls the operation projection held between the two fingers. Here, the first surface, of the operation projection, provided with the projection or recess is caught by the user's finger more easily than the second surface of the operation projection. Therefore, the user is encouraged to pull the operation projection in a direction for pulling down (lowering) the operation projection toward the side of the second surface. Namely, the user is encouraged to pull the operation projection such that the surface, of the cap, which faces (is oriented to face) a direction that is same as the direction in which the first surface of the operation projection faces is firstly removed from the wall portion of the tank defining the inlet port. With this, the tight contact between the cap and the wall portion defining the inlet port is released firstly from the surface, among the cap, which faces the direction same as the direction in which the first surface of the operation projection faces, and the cap becomes easily removable from the inlet port. As a result, the operation load of the user when removing the cap from the inlet port can be reduced.

According to the liquid storage apparatus of the sixth aspect of the related teaching, it is possible to provide a liquid storage apparatus provided with a cap capable of realizing both the appropriate opening/closing of an inlet port formed in a tank and the improved operability during removing of the cap by an user, and to provide a liquid consuming apparatus provided with the liquid storage apparatus.

In the liquid storage apparatus of the sixth aspect, the first surface may be formed on the rear-side of the operation projection, and the second surface may be formed on the front-side of the operation projection.

In the liquid storage apparatus of the sixth aspect, under the condition that the cap is installed in the inlet port, the operation projection may be projected from the outer surface at a position shifted from an opening central line of an opening of the inlet port in a direction in which the first surface faces.

In the liquid storage apparatus of the sixth aspect, under the condition that the cap is installed in the inlet port, a basal end portion of the operation projection may be located on an extension line extended from an outer edge portion of the inlet port in parallel to the opening central line of the opening of the inlet port.

In the liquid storage apparatus of the sixth aspect, the operation projection may have a first dimension in a first direction as a projection direction in which the operation projection is projected from the outer surface, a second dimension in a second direction orthogonal to the first direction, and a third dimension smaller than the second dimension in a third direction orthogonal to the first and second directions;

the first surface and the second surface of the operation projection may face mutually opposite directions which are parallel to the third direction.

In the liquid storage apparatus of the sixth aspect, the second surface of the operation projection may be formed with a projection or recess of which number is smaller than a number of the projection or recess formed in the first surface.

In the liquid storage apparatus of the sixth aspect, under the condition that the cap is installed in the inlet port, the outer surface may cross (may intersect) an opening central line of an opening of the inlet port, and a basal end portion of the operation projection may be located on the outer surface at a position which is shifted from the opening central line in a direction in which the first surface faces, and which is near to an outer edge portion of the outer surface than the opening central line.

Further, the operation projection may be projected from a portion, in the outer surface, including the outer edge portion of the outer surface.

In the liquid storage apparatus of the sixth aspect, the cap may further have an arm linking the tank and the second portion of the cap; and

under the condition that the cap is installed in the inlet port, the arm may be bent and the operation projection may be located between a bent portion of the arm and an opening central line of an opening of the inlet port, and the first surface of the operation projection and the arm may face each other.

Further, the arm may be formed of an elastic material so that the arm is elastically recoverable to mitigate an extent of bending of the arm under a condition that the cap is not installed in the inlet port. Alternatively, a basal portion of the arm may be connected to the tank so that the arm in a natural state stands upward.

In the liquid storage apparatus of the sixth aspect, the cap may further have an arm linking the tank and the second portion of the cap;

under the condition that the cap is installed in the inlet port, the arm may be bent and the operation projection may be located between a bent portion of the arm and an opening central line of an opening of the inlet port, and the first surface of the operation projection and the arm may face each other;

a basal portion of the arm may be connected to the tank at a location above the inlet port;

the inlet port may be open to the outside of the tank while facing obliquely upward; and

under a condition that the cap is installed in the inlet port, the operation projection may be located above the opening central line of the opening of the inlet port.

According to a seventh aspect of the related teaching, there is provided a liquid consuming apparatus including:

the liquid storage apparatus of the sixth aspect of the related teaching;

a liquid consuming section which consumes a liquid stored in the liquid storage apparatus; and

a casing which accommodates at least a part of the liquid consuming section and the liquid storage apparatus.

According to an eighth aspect of the related teaching, there is provided a liquid consuming apparatus including:

the liquid storage apparatus of the sixth aspect of the related teaching;

a liquid consuming section which consumes a liquid stored in the liquid storage apparatus; and

a casing which accommodates at least a part of the liquid consuming section and the liquid storage apparatus,

wherein the casing has a wall portion which makes contact with (abuts against) the operation projection, before making contact with (abutting against) the arm and the outer surface, under a condition that the arm undergoes elastic recovery.

What is claimed is:

1. A liquid consuming apparatus comprising:
a liquid consuming section configured to consume liquid;
a tank having a chamber configured to store the liquid which is to be consumed by the liquid consuming section, and a wall defining a part of the chamber, the tank including an inlet port formed in the tank penetrating through the wall;
a casing configured to accommodate a part of the liquid consuming section and the tank; and
a cap configured to be detachably installable in the inlet port, the cap having: a first portion having a first length extending in a first extending direction, and the first portion being provided with a forward end and a basal end opposite the forward end in the first extending direction; a second portion which is provided with a first nip surface continued to the forward end of the first portion; and a third portion which is provided with a second nip surface continued to the basal end of the first portion and facing the first nip surface of the second portion;
wherein the wall defining the inlet port formed with an opening facing a second extending direction, the wall defining the inlet port having a second length in the second extending direction;
wherein one of the cap and the wall, of the tank, defining the inlet port is formed of an elastic material;
wherein outer diameters of the first and second nip surfaces are greater than an inner diameter of the inlet port, and the first length of the first portion in the first extending direction is shorter than the second length; and
wherein the cap is configured to be installed to the inlet port so that the first portion is located inside the inlet port, the first nip surface of the second portion is located inside the tank through the inlet port, and the third portion is located outside the tank.

2. The liquid consuming apparatus according to claim 1, wherein a virtual central line of the opening of the inlet port extends in the second extending direction, and
wherein one of the cap and the wall defining the inlet port of the tank is elastically deformable, under the condition that the cap is installed in the inlet port, so that a distance between the first and second nip surfaces in the second extending direction becomes substantially same as the second length in the second extending direction.

3. The liquid consuming apparatus according to claim 1, wherein under the condition that the cap is installed in the inlet port, the first nip surface and the second nip surface are in close contact with end portions of the wall in the extending direction of the opening central line with the at least one of the cap and the wall being deformed.

4. The liquid consuming apparatus according to claim 1, wherein the second portion includes a basal end of which outer diameter is greater than that of the first portion, and a forward end of which outer diameter is decreased from the basal end toward a tip of the forward end, and an outer diameter of a tip of the forward end is smaller than the inner diameter of the inlet port.

5. The liquid consuming apparatus according to claim 1, wherein the cap further includes an arm elastically deformable and configured to link the outside of the tank and the third portion; and
under the condition that the cap is installed in the inlet port, the arm deforms deformed to bent elastically.

6. The liquid consuming apparatus according to claim 1, wherein the cap includes a hollow which is open at the second portion and which extends in the extending direction of the first portion from the second portion into the third portion via the first portion.

7. The liquid consuming apparatus according to claim 6, wherein the wall defining the inlet port includes an outer diameter smaller than an outer diameter of the third portion, and an inner diameter substantially same as an outer diameter of the first portion, and is formed to have a cylindrical shape penetrating through the wall, of the tank, partitioning the chamber from the outside of the chamber, to communicate the inside and the outside of the tank with each other.

8. The liquid consuming apparatus according to claim 7, wherein at least one of an inner circumferential surface and an outer circumferential surface of an end portion, of the wall defining the inlet port is chamfered.

9. The liquid consuming apparatus according to claim 1, wherein the third portion is provided with a projection which is projected from an outer surface of the third portion, at a position not overlapping with the opening central line of the opening of the inlet port.

10. The liquid consuming apparatus according to claim 1, wherein the liquid consuming section includes a liquid discharge head having a liquid channel connected to a liquid-outflow channel of the tank via a tube and a nozzle configured to discharge the liquid inside the liquid channel, and a liquid recovery device configured to recover the liquid discharged from the nozzle; and
under the condition that the cap is installed in the inlet port, the cap has a withstanding pressure exceeding a discharging pressure of the liquid from the nozzle.

11. A liquid consuming apparatus comprising:
a liquid consuming section configured to consume a liquid;
a tank including a chamber configured to store the liquid which is to be consumed by the liquid consuming section, and an inlet port;
a casing; and
a cap configured to be detachably installable in the inlet port, the cap having: a first portion; a second portion which is provided with an outer surface facing the outside of the tank, and a projection projected from the outer surface; and an arm which is an elastic body linking the second portion with the tank or the casing,
wherein the cap is configured to be installed to the inlet port so that the first portion is located inside the inlet port, and a second portion is located inside the tank through the inlet port,
the outer surface of the second portion is configured to intersect with an opening central line of an opening of the inlet port under the condition that the cap is installed in the inlet port,
the arm is elastically deformed under the condition that the cap is installed in the inlet port;
the arm includes a basal portion which is supported by one of the tank and the casing so that, under a condition that the cap is removed from the inlet port, elastic deformation of the arm is restored and a forward end of the arm at which the arm is connected to the second portion is rotated about the basal portion as a rotational center;
one of the casing and the tank has a wall configured to abut against the operation projection of the cap; and
under a condition that the arm is rotated so that the projection of the cap abuts against the wall, gaps are defined between the wall and the arm and between the wall and the outer surface of the second portion.

12. The liquid consuming apparatus according to claim 11, wherein the operation projection of the cap is projected so that gaps are formed between the wall and the arm and between the wall and the outer surface of the second portion in a state that the projection of the cap abuts against the wall.

13. The liquid consuming apparatus according to claim 11, wherein the gap between the wall and the arm is greater than the gap between the wall and the outer surface of the second portion.

14. The liquid consuming apparatus according to claim 11, wherein the basal portion of the arm is supported by one of the tank and the casing, in a state that at least the basal portion of the arm assumes a standing posture in a natural state thereof, so that the forward end of the arm is rotated upward under the condition that the cap is removed from the inlet port.

15. The liquid consuming apparatus according to claim 14, wherein the arm is configured to support the cap at a location higher than the inlet port, under a condition that the arm is in the standing posture.

16. The liquid consuming apparatus according to claim 11, wherein under the condition that the cap is installed in the inlet port, the projection is projected from the outer surface at a position not overlapping with the opening central line of the opening of the inlet port.

17. The liquid consuming apparatus according to claim 11, wherein under the condition that the cap is installed in the inlet port, a basal end of the projection is located on an extension line extended from an outer edge portion of the inlet port in parallel to the opening central line of the opening of the inlet port.

18. The liquid consuming apparatus according to claim 11, wherein under the condition that the cap is installed in the inlet port, the projection is projected from the outer surface at a position shifted from the opening central line of the opening of the inlet port in a direction toward the arm.

19. The liquid consuming apparatus according to claim 11, wherein under the condition that the cap is installed in the inlet port, the arm is bent and the projection is located between a bent portion of the arm and the opening central line of the opening of the inlet port.

20. The liquid consuming apparatus according to claim 11, wherein under the condition that the cap is installed in the inlet port, the arm is connected to one of the tank and the casing at the basal portion of the arm,
the arm including a first extending portion extending upward from the basal portion, a second extending portion extending downward to be connected to the second portion, and a connector connecting the first and second extending portion, the connector being curved to make a U-turn in an up-down direction.

21. The liquid consuming apparatus according to claim 20, wherein the projection has a first dimension in a first direction as a projection direction in which the projection is projected from the outer surface, a second dimension in a second direction orthogonal to the first direction, and a third dimension smaller than the second dimension in a third direction orthogonal to the first and second directions;
the projection has a first surface and a second surface which is a reverse side of the first surface;
the first surface faces the arm under a condition that the cap is installed in the inlet port; and
at least one of a projection and a recess is formed in the first surface.

22. The liquid consuming apparatus according to claim 17, wherein the second surface is formed with at least one of a projection and a recess of which number is smaller than a number of the at least one of the projection and recess formed in the first surface.

23. The liquid consuming apparatus according to claim 14, wherein the inlet port is open to the outside of the tank while facing obliquely upward; and the basal portion of the arm is located above the inlet port.
